(19) United States
(12) Patent Application Publication
(10) Pub. No.: US 2011/0251082 A1
(43) Pub. Date: Oct. 13, 2011

(54) BIOMARKERS FOR BREAST CANCER

(75) Inventors: Hong-Lin Chan, Hsinchu (TW); Hsiu-Chuan Chou, Hsinchu (TW); Tzu-Chia Lai, Hsinchu (TW); Yi-Wen Chen, Hsinchu (TW); Ping-Chiang Lyu, Hsinchu (TW); Tian -Ren Lee, Hsinchu (TW); Hsin-Tsu Chan, Hsinchu (TW); Hsin-Hsin Shen, Hsinchu (TW); Wei-Ta Lee, Hsinchu (TW); Szu-Ting Lin, Hsinchu (TW); Ying-Chieh Lu, Hsinchu (TW); Chieh-Lin Wu, Hsinchu (TW)

(73) Assignee: NATIONAL TSING HUA UNIVERSITY, Hsinchu (TW)

(21) Appl. No.: 12/756,927

(22) Filed: Apr. 8, 2010

(51) Int. Cl. C40B 30/04; C40B 30/00; C40B 40/10

(52) U.S. Cl. 506/9; 506/18; 506/7

(57) ABSTRACT

The present invention uses 2-dimensional differential gel electrophoresisgel (2D-DIGE) and mass spetrum techniques to identify breast cancer biomarkers in transformed breast cells. In summary, the present invention identifies numerous putative breast cancer markers from various stages of breast cancer. The results of the invention aids in developing proteins identified as useful diagnostic and therapeutic candidates on breast cancer research.

### FIELD OF THE INVENTION

The present invention relates to biomarkers for breast cancer. More specifically, the invention relates to biomarkers that can be used in diagnosis, determination of disease severity, and monitoring of therapeutic response of patients with breast cancer. The method is based on the use of 2-dimensional differential gel electrophoresisgel (2D-DIGE) to quantitatively identify biomarkers in breast cancer.

### BACKGROUND OF THE INVENTION

Breast cancer is one of the leading causes of death among women around the world. The 5-year survival rate for breast cancer is close to 97% when tumors are confined to breast tissue, but decrease dramatically to 23% when tumors have metastasized to other organs at the time of diagnosis. Presymtomatic screening to detect early-stage breast cancer while it is still resectable with potential for cure can greatly reduce breast cancer-related mortality. Unfortunately, only 63% (1992-1999, US) of the breast cancers are localized at the time of diagnosis (Jemal, A. et al. (2004) CA Cancer J. Clin. 54:8-29). Small lesions are frequently missed and may not be visible, even by mammography, particularly in young women and women with dense breast tissue. Molecular markers that can potentially identify these small lesions that are invisible to imaging techniques will provide a real opportunity to treat a neoplasm before it invades tissue.

Previous inventions indicate that the transformation and metastasis of normal breast cells are correlated to altered expression in both transcription and translation levels (Kulasingam, V. & Diamandis, E. P. Mol. Cell. Proteomics 2007, 6, 1997). To better understand the molecular mechanisms associated with tumorigenesis and metastasis, it is necessary to identify the gene expression signatures and protein expression markers among normal breast cells, noninvasive breast cancer cells, and invasive breast cancer cells. At the transcription level, microarray strategies have been used to classify breast tumors as highly invasive and noninvasive cancer. At the translation level, proteomic strategies have been used to discern cancer markers from noninvasive and invasive breast cells. Nagaraja et al. compared the proteomic profiling of cell lines corresponding to normal breast cells, non-invasive breast cancer cells, and invasive breast cancer cells using 2-DE (Nagaraja, G. M.; Othman, M.; Fox, B. P.; Alsaber, R.; Pellegrino, C. M.; Zeng, Y.; Khanna, R.; Tamburini, P.; Swaroop, A.; Kandpal, R. P. Oncogene 2006, 25, 2328). Although they identified 26 spots as potential cancer markers, no statistical analysis was included in their study. Pucci-Minafra et al. compared a ductal infiltrating carcinoma-derived cell line with a non-tumoral mammary epithelial cell line using 2-DE, silver staining, immunodetection, and N-terminal sequencing and identified 58 differentially expressed proteins (Pucci-Minafra, I.; Fontana, S.; Cancemi, P.; Alaimo, G; Minafra, S. Ann. N.Y. Acad. Sci. 2002, 963, 122). In contrast to these cell line based experiments, Pawlik analyzed differentially expressed proteins among nipple aspirate fluid samples from tumor-bearing and disease-free breasts (Pawlik, T. M.; Hawke, D. H.; Liu, Y.; Krishnamurthy, S.; Fritsche, H.; Hunt, K. K.; Kuerer, H. M. BMC. Cancer 2006, 6, 68). Although these identified proteins are primarily abundant proteins, few of them have been validated as biomarkers.

### BRIEF DESCRIPTION OF THE DRAWINGS

FIG. 1. Optimization of starvation time for secretomic analysis. MCF-10A, MCF-7 and MDA-MB-231 on cell culture dishes were used to check starvation induced cell autolysis by detecting the release of cytoplasmic proteins, LDH and β-tubulin in serum-free media. The serum-free media were harvested and concentrated 1000-fold at indicative starvation periods prior to performing immunoblotting analysis.

FIG. 2. Secretomic comparisons across MCF-10A, MCF-7 and MDA-MB-231 cells using 2D-DIGE. Protein sample (50 μg each) enriched from serum-free media was labeled with Cy-dyes and separated using 24 cm, pH 3-10 non-linear IPG strips. 2D-DIGE images of MCF-10A, MCF-7, and MDA-MB-231 at appropriate excitation and emission wavelengths were pseudo-colored and overlaid with ImageQuant Tool (GE Healthcare).

FIG. 3. Percentage of secreted proteins identified from serum-free media by 2D-DIGE/MALDI-TOF MS for MCF-10A, MCF-7 and MDA-MB-231 cells according to their sub-cellular locations (A) and biological functions (B).

FIG. 4. Proteomic comparisons among MCF-10A, MCF-7 and MDA-MB-231 cells using 2D-DIGE. Protein samples (150 μg each) purified from total cell lysates were labeled with Cy-dyes and separated using 24 cm, pH 3-10 non-linear IPG strips. 2D-DIGE images of MCF-10A, MCF-7 and MDA-MB-231 at appropriate excitation and emission wavelengths were pseudo-colored and overlaid with ImageQuant Tool (GE Healthcare).

FIG. 5. Percentage of total cellular proteins identified by 2D-DIGE/MALDI-TOF MS for MCF-10A, MCF-7 and MDA-MB-231 cells according to their sub-cellular locations (A) and biological functions (B).

FIG. 6. Representative immunoblotting and immunofluorescent analyses for selected differentially expressed proteins identified by proteomic analysis in MCF-10A, MCF-7 and MDA-MB-231 cells. The levels of identified proteins in serum-free media, (A) Cyclophilin A, (B) 14-3-3 delta and (C) Peroxiredoxin 2 and total cellular proteins, (D) Profilin, (E) Cathepsin D, (F) Annexin 2 and (G) Protein disulfide isomerase A1 in MDA-MB-231 and MCF-7 versus MCF-10A confirmed by immunoblot (left top panels), densitometry results with normalized values using nonspecific bands (NS) of secreted proteins and β-tubulin as loading controls (left bottom panels), protein expression map (right top panels) and three-dimensional spot image (right bottom panels). (H) MCF-10A, MCF-7 and MDA-MB-231 cells were fixed and incubated with anti-HDAC antibody and stained with a Texas Red-conjugated secondary antibody (Red). Nuclei were stained with DAPI (Blue). Each set of three fields was taken using the same exposure, and images are representative of three different fields. Scale bar=20 μm.

FIG. 7. Immunoblotting and immunofluorescence analyses of the expression and protein localization changes of newly identified putative breast cancer markers across MCF-10A, MCF-7, MDA-MB-231, MDA-MB-453 and MDA-MB-361 cells. (A) The profile of the secreted proteome changes across MCF-10A, MCF-7, MDA-MB-231, MDA-MB-453 and MDA-MB-361 cells. The serum-free media from the cell lines was concentrated and 10 μg of the total protein was resolved using SDS-PAGE and immunoblotted for MPP2 and Bestrophin 3. NS represents a nonspecific band used to show equal loading of secreted proteins. (B) 5×10⁴ MCF-10A, MCF-7, MDA-MB-231, MDA-MB-453 and MDA-MB-361 cells were seeded on cover slips before fixation and staining for Parvabumin, BANF1, PdLIM1 and IFIT3. Each set of three fields was taken using the same exposure, and images are representative of three different fields. Scale bar=20 μm.

FIG. 8. Expression profiles for proteins potentially contributing to (A) cell cycle (B) redox regulation (C) carbohydrate metabolism (D) calcium regulation (E) vascular transport (F) protease inhibition in comparing MCF-7 and MDA-MB-231 with MCF-10A. White bars represent fold change in protein expression in MDA-MB-231 versus MCF-10A. Black bars represent fold change in protein expression in MCF-7 versus MCF-10A. The vertical axis indicates the identified proteins; the horizontal axis indicates the fold change in protein expression.

### SUMMARY OF THE INVENTION

The present invention provides a breast cancer biomarker library, comprising bestrophin-3, carbonic anhydrase 2, dynein heavy chain 6, ecto-ADP-ribosyltransferase 4, GRAM domain-containing protein 2, interferon-induced protein with tetratricopeptide repeat 3, phosphoglycerate mutase 1, proteasome subunit alpha type-1, proteasome subunit alpha type-3, rab GTPase-binding effector protein 2, Ras-related protein Rab-2B, selenium-binding protein 1, transmembrane protein C14orf180, vascular protein sorting-associated protein 54, achaete-scute homologue 4, aconitate hydratase, aminopeptidase B, annexin A3, barrier-to-autointegration factor, bifunctional purine biosynthesis, calumenin, carbonic anhydrase 2, coiled-coil domain-containing protein, erlin-2, F-actin-capping protein subunit beta, flavin reductase, fructose-1,6-biphosphatase 1, fructose-biphosphate ldolase A, heat shock protein 75 kDa, heterogeneous nuclear ribonucleoproteins A2/B1, leukotriene A-4 hydrolase, microfibrillar-associated protein 3 like, microtubule-associated protein RP, nuclear distribution protein nudE homologue 1, parvalbumin alpha, PDZ and LIM domain protein 1, peptidylprolyl isomerase domain and WD repeat-containing protein 1, phosphoserine aminotransferase, plastin-3, programmed cell death 6-interacting protein, proteasome activator complex subunit 1, proteasome activator complex subunit 2, protein canopy homologue 2, protein CASC2, protein disulfide-isomerase A6, protein SHQ1, Rab GDP dissociation inhibitor beta, reticulocalbin-2, Rho GTPase-activating protein 25, Rho GTPase-activating protein 5, ribonuclease inhibitor, selenium-binding protein 1, septin-11, septin-8, serine/threonine-protein kinase Nek7, serine/threonine-protein kinase PCTAIRE-1, small ubiqutin-related modifier 3, stress-induced phosphoprotein 1, thioredoxin domain-containing protein 5, ubiquitin-conjugating enzyme E2, UPF0492 protein C20orf94, voltage-dependent anion-selective channel protein and zinc finger protein 433.

The present invention also provides a method of predicting an increased likelihood of developing breast cancer progression of a subject comprising:
(a) detecting the expression of at least one biomarker in a sample from a subject with bioassays, wherein the biomarker is selected from the biomarker library aformentioned; and
(b) comparing the pattern of biomarker expression in the previous step to a reference biomarker expression pattern from normal tissue, wherein at least one fold of increasing or decreasing biomarker expression relative to the reference indicating an increased likelihood of breast cancer development.

### DETAILED DESCRIPTION OF THE INVENTION

The present invention provides a biomarker library for breast cancer, and a method of predicting an increased likelihood of developing breast cancer progression using the same.

### Biomarker Library

Breast cancer is the leading cause of cancer-induced mortality in women. Early detection of breast cancer greatly improves its survival rates. The identification of cellular targets that play a role in highly invasive breast cancer may also contribute to a better understanding of the biological mechanisms inherent in the aggressive progression of cancer and may also be used in the development of new diagnostic or therapeutic strategies for breast cancer.

Accordingly, the aim of the present invention is to discover biomarkers with the greatest potential to facilitate early detection of breast cancer and monitor the progress of breast tumorigenesis. Numerous proteins, including bestrophin-3 and parvalbumin, are highly expressed in both low-invasive and aggressive breast cancer cells and are verified as breast cancer markers in this invention. Importantly, several of these identified proteins, including bestrophin-3, GRAMD2, and nuclear distribution protein nudE homolog 1, have not been reported in previous breast cancer studies, thus implying these proteins are valuable breast cancer markers.

Biomarkers of the present invention can be used in diagnosis, including determination of disease severity and monitoring of therapeutic response of patients with breast cancer. The biomarker library is listed as follows: bestrophin-3, carbonic anhydrase 2, dynein heavy chain 6, ecto-ADP-ribosyltransferase 4, GRAM domain-containing protein 2, interferon-induced protein with tetratricopeptide repeat 3, phosphoglycerate mutase 1, proteasome subunit alpha type-1, proteasome subunit alpha type-3, rab GTPase-binding effector protein 2, Ras-related protein Rab-2B, selenium-binding protein 1, transmembrane protein C14orf180, vascular protein sorting-associated protein 54, achaete-scute homologue 4, aconitate hydratase, aminopeptidase B, annexin A3, barrier-to-autointegration factor, bifunctional purine biosynthesis, calumenin, carbonic anhydrase 2, coiled-coil domain-containing protein, erlin-2, F-actin-capping protein subunit beta, flavin reductase, fructose-1,6-biphosphatase 1, fructose-biphosphate ldolase A, heat shock protein 75 kDa, heterogeneous nuclear ribonucleoproteins A2/B1, leukotriene A-4 hydrolase, microfibrillar-associated protein 3 like, microtubule-associated protein RP, nuclear distribution protein nudE homologue 1, parvalbumin alpha, PDZ and LIM domain protein 1, peptidylprolyl isomerase domain and WD repeat-containing protein 1, phosphoserine aminotransferase, plastin-3, programmed cell death 6-interacting protein, proteasome activator complex subunit 1, proteasome activator complex subunit 2, protein canopy homologue 2, protein CASC2, protein disulfide-isomerase A6, protein SHQ1, Rab GDP dissociation inhibitor beta, reticulocalbin-2, Rho GTPase-activating protein 25, Rho GTPase-activating protein 5, ribonuclease inhibitor, selenium-binding protein 1, septin-11, septin-8, serine/threonine-protein kinase Nek7, serine/threonine-protein kinase PCTAIRE-1, small ubiqutin-related modifier 3, stress-induced phosphoprotein 1, thioredoxin domain-containing protein 5, ubiquitin-conjugating enzyme E2, UPF0492 protein C20orf94, voltage-dependent anion-selective channel protein and zinc finger protein 433.

### Predicting Method

When using biomarkers in diagnosis, the present invention provides a direct way of predicting an increased likelihood of developing breast cancer progression of a subject comprising following steps:
(a) detecting the expression of at least one biomarker in a sample from a subject with bioassays, wherein the biomarker is selected from the biomarker library aforementioned; and
(b) comparing the pattern of biomarker expression in the previous step to a reference biomarker expression pattern from normal tissue, wherein at least one fold of increasing or decreasing biomarker expression relative to the reference indicating an increased likelihood of breast cancer development.

The expression pattern indicates the quantity of biomarker expression. In a better embodiment, the increasing or decreasing of biomarker expression is 1.5 fold relative to the biomarker expression of normal tissue.

The method further comprises applying software for protein expression comparison between normal tissue and tumor tissue.

The breast cancer progression includes the presence or absence of breast tumor, the stage of breast cancer and the effectiveness of breast cancer treatment.

The stage of breast cancer includes invasive and non-invasive tumor pregression. Invasive tumor is another synonym of cancer, and the name refers to invasion of surrounding tissues. Non-invasive tumor is a neoplasm which is not invasive but has the potential to progress to cancer (become invasive) if left untreated.

A neoplasm is the abnormal proliferation of cells. The growth of this clone of cells exceeds, and is uncoordinated with, that of the normal tissues around it. The growth persists in the same excessive manner even after cessation of the stimuli. It usually causes a lump or tumor.

The subject mentioned herein is human or mammal, and the sample is selected from blood, serum, plasma, ductal lavage fluid and nipple aspiration fluid.

The bioassay used herein comprises immunoassay, electrophoresis and mass spectrum.

The immunoassay is measured using an immunoblotting, especially an antibody-based assay. The antibody-based assay used herein is for biomarker detection, comprsing at least one vessel for antibody and biomarker interaction and a detectable label to attached with antibody. Useful detectable labels include but are not limited to radioactive labels such as ³²P, ³H, and ¹⁴C; fluorescent dyes such as fluorescein isothiocyanate (FITC), rhodamine, lanthanide phosphors, Texas red, and ALEXA Fluor Dyes™ (Molecular Probes), CY™ dyes (Amersham), Spectrum Dyes (Abbott Labs); electron-dense reagents such as gold; enzymes such as horseradish peroxidase, beta-galactosidase, luciferase, and alkaline phosphatase; colorimetric labels such as colloidal gold; magnetic labels such as those sold under the mark DYNABEADS™; biotin; dioxigenin; or haptens and proteins for which antisera or monoclonal antibodies are available. The label can be directly incorporated into the polynucleotide, or it can be attached to a molecule which hybridizes or binds to the polynucleotide. The labels may be coupled to the isolated polynucleotides by any means known to those of skill in the art. In various embodiments, the isolated polynucleotides are labeled using nick translation, PCR, or random primer extension (see, e.g., Sambrook et al. supra). Methods for detecting the label include, but are not limited to spectroscopic, photochemical, biochemical, immunochemical, physical or chemical techniques.

The electrophoresis used herein is 2-dimensional differential gel electrophoresisgel (2D-DIGE), which works efficiently to identify the quantity of breast cancer biomarker expression.

2-DE is currently a key technique in profiling thousands of proteins within biological samples and plays a role complementary to LC/MS-based proteomic analysis. However, reliable quantitative comparisons between gels and gel-to-gel variations remain the primary challenge in 2-DE analysis. A significant improvement in the gel-based analysis of protein quantitation and detection was achieved by the introduction of 2D-DIGE, which can co-detect numerous samples in the same 2-DE. This approach minimizes gel-to-gel variations and compares the relative amount of protein features across different gels using an internal fluorescent standard. Moreover, the 2D-DIGE technique has the advantages of a broader dynamic range, higher sensitivity, and greater reproducibility than traditional 2-DE. This innovative technology relies on the pre-labeling of protein samples with fluorescent dyes (Cy2, Cy3 and Cy5) before electrophoresis. Each dye has a distinct fluorescent wavelength, allowing multiple experimental samples with an internal standard to be simultaneously separated in the same gel. The internal standard, which is a pool of an equal amount of the experimental protein samples, helps provide accurate normalization data and increase statistical confidence in relative quantitation among gels.

Whether or not comparisons of normal cell lines with cancer cell lines actually reflect common changes associated with cancer and can be successfully developed into clinically useful biomarkers or therapeutic targets remains debatable. Thus, a direct comparison of cancer tissue with normal tissue is the best theoretical method of obtaining protein expression signatures during tumor progression. However, a direct comparison of clinical samples increases the amount of false positives due to the heterogeneity of tumor specimens, which interferes with the identification of tumor-specific markers. For this reason, well-characterized model cell lines established from normal and tumor tissue are recognized as more informative in cancer proteomics research.

In the field of breast cancer research, MCF-10A, MCF-7 and MDA-MB-231 are widely used to represent normal luminal epithelial cells, non-invasive breast cancer cells derived from the luminal duct and invasive breast cancer cells derived from the same tissue, respectively. The present invention compares the proteomic profiles of total cellular proteins and secreted proteins of this cell model system using 2D-DIGE to quantitatively identify biomarkers in breast cancer, wherein the biomarkers reflect the progression of tumorigenesis.

The results show differentially expressed protein profiles across normal and transformed breast cell lines, ranging from extracellular secreted proteins and intracellular proteins. The 2D-DIGE strategy is powerful enough to identify numerous breast cancer signatures and offers a complementary role to LC/MS-based proteomic analysis. Even though the global coverage of protein mixtures identified by LC-MS based analysis is generally higher than that of 2-DE based analysis, 2-DE based analysis offers some distinct advantages, such as direct protein quantification at protein isoform levels instead of peptide levels to reduce analytical variations.

The examples below are non-limiting but merely representative of various aspects and features of the present invention.

### EXAMPLE 1

### Chemicals and Reagents

Generic chemicals were purchased from Sigma-Aldrich (St. Louis, USA), while reagents for 2D-DIGE were purchased from GE Healthcare (Uppsala, Sweden). All primary antibodies were purchased from Abcam (Cambridge, UK) and anti-mouse, anti-goat and anti-rabbit secondary antibodies were purchased from GE Healthcare (Uppsala, Sweden). All chemicals and biochemicals used in the present invention were of analytical grade.

### Cell Lines and Cell Cultures

The breast epithelial cell line MCF-10A was from National Health Research Institute, Taiwan. The breast cancer cell lines MCF-7, MDA-MB-231, MDA-MB-453 and MDA-MB-361 were purchased from American Type Culture Collection (ATCC), Manassas, Va. MCF-10A was maintained in Dulbecco's Modified Eagle's medium and F-12 medium (DMEM/F-12) supplemented with 5% horse serum, L-glutamine (2 mM), streptomycin (100 μg/mL), penicillin (100 IU/mL), epidermal growth factor (20 ng/ml) (all from Gibco-Invitrogen Corp., UK), insulin (10 μg/ml) (Sigma) and hydrocortisone (0.5 μg/ml) (Sigma). MCF-7, MDA-MB-231, MDA-MB-453 and MDA-MB-361 were maintained in Dulbecco's Modified Eagle's medium (DMEM) supplemented with 10% (v/v) fetal calf serum (FCS), L-glutamine (2 mM), streptomycin (100 μg/mL), and penicillin (100 IU/mL) (all from Gibco-Invitrogen Corp., UK). All cells were incubated at 37° C. and 5% CO₂.

### Sample Preparation for Proteomic Analysis

Cells in normal growth medium at ˜80% confluence were used for proteomic analysis. For total cellular protein analysis, cells were washed in chilled 0.5×PBS and scraped in 2-DE lysis buffer containing 4% w/v CHAPS, 7M urea, 2M thiourea, 10 mM Tris-HCl, pH8.3, 1 mM EDTA. Lysates were homogenized by passage through a 25-gauge needle 10 times, insoluble material was removed by centrifugation at 13000 rpm for 30 min at 4° C., and protein concentrations were determined using Coomassie Protein Assay Reagent (BioRad). For secreted protein analysis, approximately 1.25×10⁸ cells were seeded into twenty-five 175-cm² cell culture plates for each cell line. After 2 days of incubation, the DMEM or DMEM/F-12 media were discarded, and the cells were rinsed three times with PBS. Subsequently, 375 ml of serum-free DMEM or DMEM/F-12 media were added for an additional 30 hours. The media were collected and filtered with 0.45 μm microfilters to remove cell debris and then concentrated 1000 fold with 10-kDa molecular mass cutoff concentrators (Millipore). The concentrated media were then precipitated by adding 1 volume of 100% TCA (at −20° C.) to 4 volumes of sample and incubated for 10 min. at 4° C. The precipitated protein was then recovered by centrifugation at 13000 rpm for 10 min., and the resulting pellet was washed twice with ice-cold acetone. Air-dried pellets were resuspended in 2-DE lysis buffer for protein quantification.

### EXAMPLE 2

### 2D-DIGE and Gel Image Analysis

Before performing 2D-DIGE, protein samples were labeled with N-hydroxy succinimidyl ester-derivatives of the cyanine dyes Cy2, Cy3 and Cy5. Briefly, 150 μg of protein sample was minimally labeled with 375 pmol of either Cy3 or Cy5 for comparison on the same 2-DE. To facilitate image matching and cross-gel statistical comparison, a pool of all samples was also prepared and labeled with Cy2 at a molar ratio of 2.5 pmol Cy2 per μg of protein as an internal standard for all gels. Thus, the triplicate samples and the internal standard could be run and quantify on multiple 2-DE. The labeling reactions were performed in the dark on ice for 30 min and then quenched with a 20-fold molar ratio excess of free L-lysine to dye for 10 min. The differentially Cy3- and Cy5-labeled samples were then mixed with the Cy2-labeled internal standard and reduced with dithiothreitol for 10 min. IPG buffer, pH3-10 nonlinear (2% (v/v), GE Healthcare) was added and the final volume was adjusted to 450 μl with 2D-lysis buffer for rehydration. The rehydration process was performed with immobilized non-linear pH gradient (IPG) strips (pH3-10, 24 cm) which were later rehydrated by CyDye-labeled samples in the dark at room temperature overnight (at least 12 hours). Isoelectric focusing was then performed using a Multiphor II apparatus (GE Healthcare) for a total of 62.5 kV-h at 20° C. Strips were equilibrated in 6M urea, 30% (v/v) glycerol, 1% SDS (w/v), 100 mM Tris-HCl (pH8.8), 65 mM dithiothreitol for 15 min and then in the same buffer containing 240 mM iodoacetamide for another 15 min. The equilibrated IPG strips were transferred onto 26×20-cm 12.5% polyacrylamide gels casted between low fluorescent glass plates. The strips were overlaid with 0.5% (w/v) low melting point agarose in a running buffer containing bromophenol blue. The gels were run in an Ettan Twelve gel tank (GE Healthcare) at 4 Watt per gel at 10° C. until the dye front had completely run off the bottom of the gels. Afterward, the fluorescence 2-DE was scanned directly between the low fluorescent glass plates using an Ettan DIGE Imager (GE Healthcare). This imager is a charge-coupled device-based instrument that enables scanning at different wavelengths for Cy2-, Cy3-, and Cy5-labeled samples. Gel analysis was performed using DeCyder 2-D Differential Analysis Software v7.0 (GE Healthcare) to co-detect, normalize and quantify the protein features in the images. Features detected from non-protein sources (e.g. dust particles and dirty backgrounds) were filtered out. Spots displaying a ≧1.5 average-fold increase or decrease in abundance with a p-value <0.05 were selected for protein identification.

### Protein Staining

Colloidal coomassie blue G-250 staining was used to visualize CyDye-labeled protein features in 2-DE. Bonded gels were fixed in 30% v/v ethanol, 2% v/v phosphoric acid overnight, washed three times (30 min each) with ddH₂O and then incubated in 34% v/v methanol, 17% w/v ammonium sulphate, 3% v/v phosphoric acid for 1 hr., prior to adding 0.5 g/liter coomassie blue G-250. The gels were then left to stain for 5-7 days. No destaining step was required. The stained gels were then imaged on an ImageScanner III densitometer (GE Healthcare).

### In-Gel Digestion

Excised post-stained gel pieces were washed three times in 50% acetonitrile, dried in a SpeedVac for 20 min., reduced with 10 mM dithiothreitol in 5 mM ammonium bicarbonate pH 8.0 (Ammonium bicarbonate) for 45 minutes at 50° C. and then alkylated with 50 mM iodoacetamide in 5 mM Ammonium bicarbonate for 1 hr. at room temperature in the dark. The gel pieces were then washed three times in 50% acetonitrile and vacuum-dried before reswelling with 50 ng of modified trypsin (Promega) in 5 mM Ammonium bicarbonate. The pieces were then overlaid with 10 μl of 5 mM Ammonium bicarbonate and trypsinized for 16 hr at 37° C. Supernatants were collected, peptides were further extracted twice with 5% trifluoroacetic acid in 50% acetonitrile and the supernatants were pooled. Peptide extracts were vacuum-dried, resuspended in 5 μl ddH₂O, and stored at −20° C. prior to MS analysis.

### EXAMPLE 3

### Protein Identification by MALDI-TOF MS

Extracted proteins were cleaved with a proteolytic enzyme to generate peptides, then a peptide mass fingerprinting (PMF) database search following MALDI TOF mass analysis was employed for protein identification. Briefly, 0.5 μl of tryptic digested protein sample was first mixed with 0.5 μl of a matrix solution containing α-cyano-4-hydroxycinammic acid at a concentration of 1 mg in 1 ml of 50% acetonitrile (v/v)/0.1% trifluoroacetic acid (v/v), spotted onto an anchorchip target plate (Bruker Daltonics) and dried. The peptide mass fingerprints were acquired using an Autoflex III mass spectrometer (Bruker Daltonics) in reflector mode. The algorithm used for spectrum annotation was SNAP (Sophisticated Numerical Annotation Procedure). This process used the following detailed metrics: Peak detection algorithm: SNAP; Signal to noise threshold: 25; Relative intensity threshold: 0%; Minimum intensity threshold: 0; Maximal number of peaks: 50; Quality factor threshold: 1000; SNAP average composition: Averaging; Baseline subtraction: Median; Flatness: 0.8; MedianLevel: 0.5. The spectrometer was also calibrated with a peptide calibration standard (Bruker Daltonics) and internal calibration was performed using trypsin autolysis peaks at m/z 842.51 and m/z 2211.10. Peaks in the mass range of m/z 800-3000 were used to generate a peptide mass fingerprint that was searched against the Swiss-Prot/TrEMBL database (v57.12) with 513877 entries using Mascot software v2.2.06 (Matrix Science, London, UK). The following parameters were used for the search: Homo sapiens; tryptic digest with a maximum of 1 missed cleavage; carbamidomethylation of cysteine, partial protein N-terminal acetylation, partial methionine oxidation and partial modification of glutamine to pyroglutamate and a mass tolerance of 50 ppm. Identification was accepted based on significant MASCOT Mowse scores (p<0.05), spectrum annotation and observed versus expected molecular weight and pI on 2-DE.

### EXAMPLE 4

### Immunoassay

Immunoblotting was used to validate the differential expression of mass spectrometry identified proteins. Cells were lysed with a lysis buffer containing 50 mM HEPES pH 7.4, 150 mM NaCl, 1% NP40, 1 mM EDTA, 2 mM sodium orthovanadate, 100 μg/mL AEBSF, 17 μg/mL aprotinin, 1 μg/mL leupeptin, 1 μg/mL pepstatin, 5 μM fenvalerate, 5 μM BpVphen and 1 μM okadaic acid prior to protein quantification with Coomassie Protein Assay Reagent (BioRad).

30 μg of protein samples were diluted in Laemmli sample buffer (final concentrations: 50 mM Tris pH 6.8, 10% (v/v) glycerol, 2% SDS (w/v), 0.01% (w/v) bromophenol blue) and separated by 1D-SDS-PAGE following standard procedures. After electroblotting separated proteins onto 0.45 μm Immobilon P membranes (Millipore), the membranes were blocked with 5% w/v skim milk in TBST (50 mM Tris pH 8.0, 150 mM NaCl and 0.1% Tween-20 (v/v)) for 1 hour. Membranes were then incubated in primary antibody solution in TBS-T containing 0.02% (w/v) sodium azide for 2 hours. Membranes were washed in TBS-T (3minutes, 10 times) and then probed with the appropriate horseradish peroxidase-coupled secondary antibody (GE Healthcare). After further washing in TBS-T, immunoprobed proteins were visualized using an enhanced chemiluminescence method (Visual Protein Co.).

For immunofluorescence staining, cells were plated onto coverslips (VWR international) for overnight incubation. The cells were fixed with PBS containing 4% (v/v) paraformaldehyde for 25 minutes, washed three times with PBS, and followed by permeabilization in PBS containing 0.2% (v/v) Triton X-100 for 10 minutes. Coverslips were rinsed and blocked in PBS containing 5% (w/v) BSA for 10 minutes before incubation with primary antibodies diluted in 2.5% BSA/PBS for 1 hour. After three washings with PBS, samples were incubated with the appropriate fluorescently labelled secondary antibodies diluted in 2.5% BSA/PBS for 1 hour. Coverslips were then washed three times with PBS and at least twice with ddH₂O before mounting in Vectashield mounting medium (Vector Lab). Coverslip edges were sealed with nail polish onto glass slides (BDH) and then dried in the dark at 4° C. For image analysis, cells were imaged using a Zeiss Axiovert 200M fluorescent microscope (Carl Zeiss Inc., Germany). The laser intensities used to detect the same immunostained markers from different cell lines were identical, and none of the laser intensities used to capture images was saturated.

### EXAMPLE 5

### Optimization of Cell Conditions for Secreted Protein Analysis

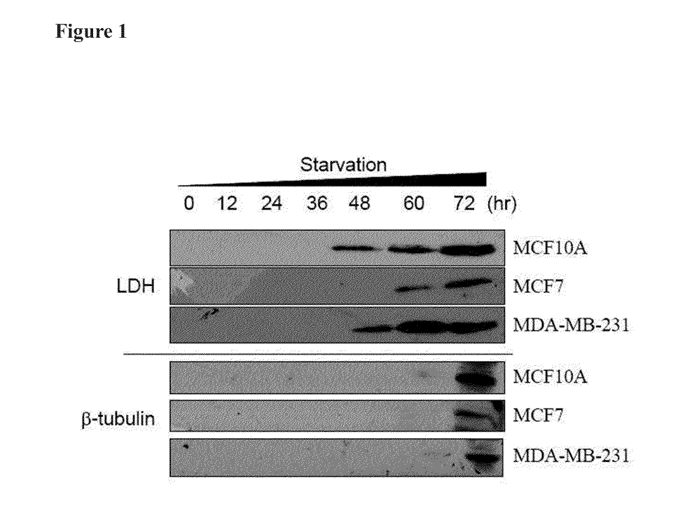

For secretomic analysis, MCF-10A, MCF-7 and MDA-MB-231 were grown on cell culture dishes and the confluency of cells was checked prior to incubation in serum-free culture media to ensure that no other exogenous proteins were present. To minimize cell autolysis induced by starvation and to maximize secreted protein concentration in the media, the starvation time of each cell line was optimized. Through immunoblotting, the LDH and β-tubulin levels were detected in the 1000-fold concentrated serum-free media starting at 48˜60 hours and at 60˜72 hours, respectively (FIG. 1). LDH and β-tubulin are both cytoplasmic proteins and their levels in the media represent the amount of cell death taking place in cell culture.

Accordingly, a starvation period of 30 hours was chosen for further 2D-DIGE based secretomic analysis.

### EXAMPLE 6

DIGE and MALDI-TOF Analysis of Secretomes among MCF-10A, MCF-7 and MDA-MB-231 Cells

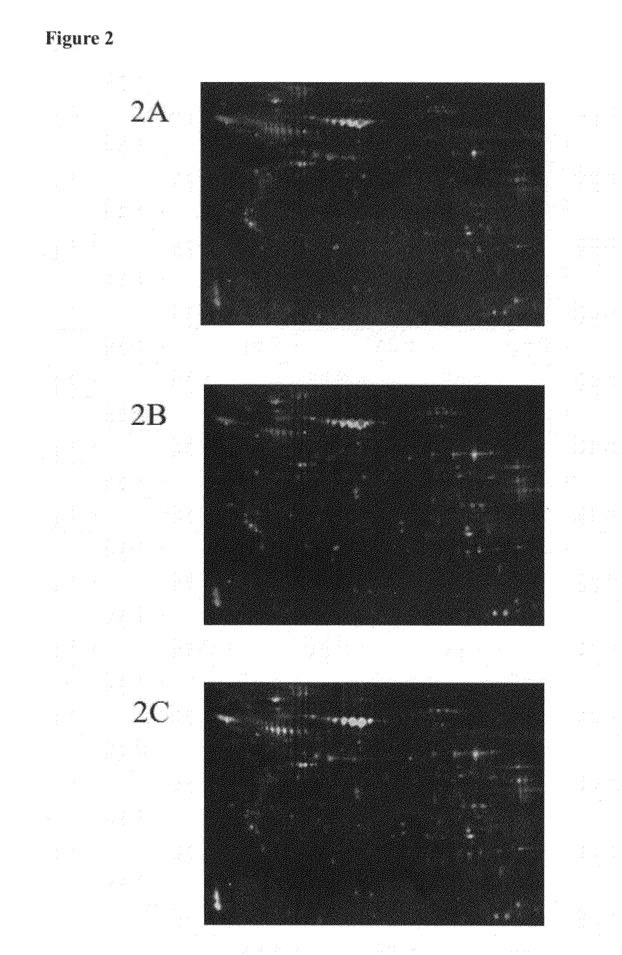

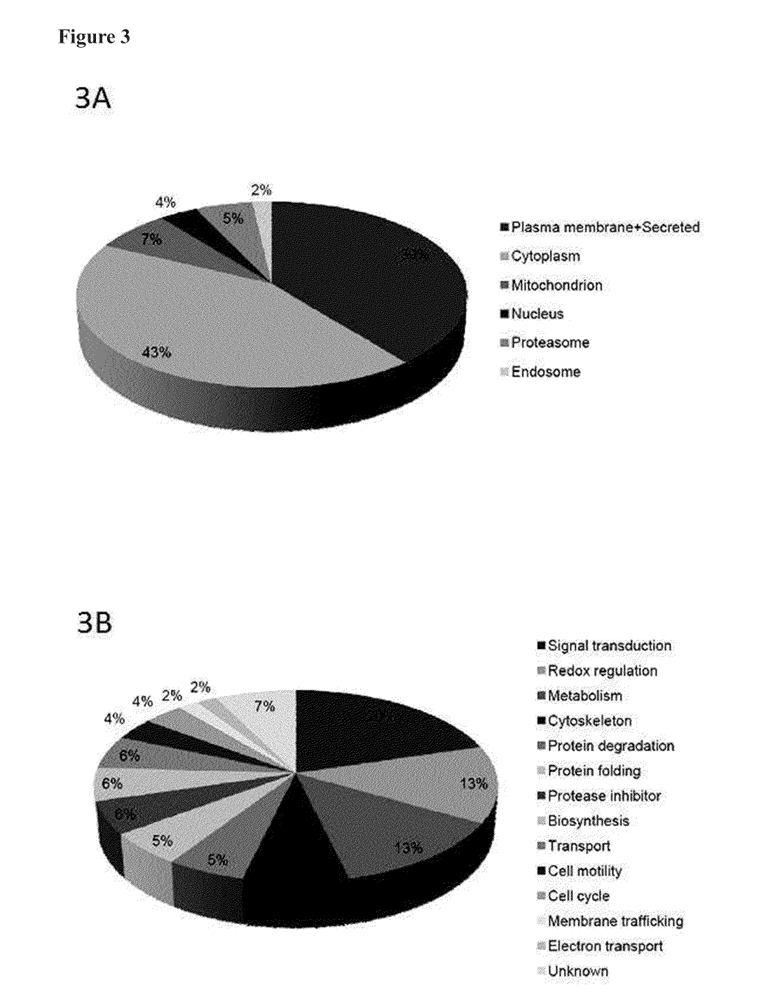

Proteins secreted from each cell type were enriched from the serum-free medium followed by labeling with CyDyes for 2D-DIGE analysis. The secretomic profiling of MCF-10A, MCF-7 and MDA-MB-231 were visualized using a fluorescence scanner and the images were superimposed using ImageQuant software (FIG. 2). To investigate the potential involvement of secreted proteins in tumorigenesis and metastasis for human breast cancer, biological variation analysis of spots showing greater than 1.5-fold change in expression with a t-test score of P value<0.05 were visually checked before confirming the alterations for protein identification. MALDI-TOF MS identification revealed 50 unique differentially expressed proteins across MCF-10A, MCF-7 and MDA-MB-231 (Table 1). Of the proteins identified, 42 were differentially expressed between MCF-7/MCF-10A, 44 of them were differentially expressed between MDA-MB-231/MCF-10A, and 37 proteins were differentially expressed between MDA-MB-231 and MCF-7. In the three cell lines investigated, 39% of the total proteins identified were extracellular and plasma membrane-anchored proteins (FIG. 3A). Most of the identified proteins were involved in signaling transduction, redox-regulation and metabolism (FIG. 3B). To our knowledge, 14 out of these identified spots, including IFIT3, have not been reported in any breast cancer related studies. Consequently, these proteins have the potential to be breast cancer markers. As expected, this 2D-DIGE experiment also identified a number of reported breast cancer markers, including Cathepsin D (Zhang, Y. G; D U, J.; Tian, X. X.; Zhong, Y. F.; Fang, W. G. Chin Med. J. (Engl.) 2007, 120, 1597) and IGFBP4 (Mita, K.; Zhang, Z.; Ando, Y.; Toyama, T.; Hamaguchi, M.; Kobayashi, S.; Hayashi, S.; Fujii, Y.; Iwase, H.; Yamashita, H. Jpn. J. Clin. Oncol. 2007, 37, 575).

Using the LC-MS/MS strategy, Kulasingam and Diamandis analyzed and compared the expressions of extracellular and membrane-bound proteins in conditioned media of three breast cells corresponding to the normal control cells and cell lines derived from stage 2 and stage 4 patients, respectively (Kulasingam, V.; Diamandis, E. P. Mol. Cell Proteomics. 2007, 6, 1997). Kulasingam's experiment identified 1062 differentially expressed proteins across these three cell lines. A comparison between Kulasingam's result and 2D-DIGE secretomic of the present invention shows that 25 out of 50 identified differentially expressed secreted proteins coincide with Kulasingam's study, indicating that both LC-MS/MS and 2D-DIGE are potential tools for discovering breast cancer markers with reasonable reproducibility. Importantly, 25 out of 50 identified proteins were not reported in Kulasingam's study or any other studies, demonstrating that 2D-DIGE plays a powerful complementary role in the assumed biomarker discovery (Table 1a & 1b).

TABLE 1a
Alphabetical list of identified differentially expressed secreted
proteins of breast cells MCF-10A, MCF-7, and MDA-MB-231.

| | | | | | Putative | Reported by |
|---|---|---|---|---|---|---|
| Accession | | MCF7/ | MDA231/ | MDA231/ | Breast | Kulasingam |
| Code | Protein name | MCF10A^{#} | MCF10A^{#} | MCF7^{#} | Markers^{##} | et al^{###} |
| P63104 | 14-3-3 protein zeta/delta | −2.25 | −4.28 | −1.85 | | K |
| O95861 | 3′(2′),5′-bisphosphate nucleotidase 1 | 1.16 | 2.89 | 2.56 | | |
| O95336 | 6-phosphogluconolactonase | 1.05 | 1.95 | 1.91 | | K |
| P60709 | Actin | 2.57 | 1.17 | −2.14 | | K |
| P60709 | Actin | 2.21 | −1.04 | −2.25 | | K |
| P15121 | Aldose reductase | 3.14 | 8.14 | 2.66 | | K |
| P06733 | Alpha-enolase | −2.57 | 1.86 | 4.94 | | K |
| P08758 | Annexin A5 | −1.03 | 3.28 | 3.47 | | K |
| Q8N1M1 | Bestrophin-3/BEST3 | 3.6 | 2.62 | −1.34 | A | |
| P00918 | Carbonic anhydrase 2 | −4.72 | −6.11 | −1.25 | B | |
| P46527 | Cyclin-dependent kinase inhibitor | 1.65 | 3.41 | 2.07 | | |
| | 1B/Cyclin-dependent kinase | | | | | |
| | inhibitor p27/p27Kip1 | | | | | |
| Q9C0G6 | Dynein heavy chain 6 | 5.07 | 2.87 | −1.71 | A | |
| Q9NPC3 | E3 ubiquitin-protein ligase | 4.92 | 5.8 | 1.22 | | |
| | CCNB1IP1 | | | | | |
| Q93070 | Ecto-ADP-ribosyltransferase 4/ | 1.75 | 1.92 | 1.14 | B | |
| | CD297/ART4 | | | | | |
| P04075 | Fructose-bisphosphate aldolase A | 1.89 | 1.15 | −1.61 | | K |
| P21266 | Glutathione S-transferase Mu 3 | 4.18 | −1.09 | −4.46 | | |
| P09211 | Glutathione S-transferase P | −5.67 | −4.47 | 1.3 | | K |
| P09211 | Glutathione S-transferase P | −13.19 | −13.28 | 1.02 | | K |
| P04406 | Glyceraldehyde-3-phosphate | −1.71 | −1.12 | 1.57 | | K |
| | dehydrogenase | | | | | |
| Q9HC38 | Glyoxalase domain-containing | −1.19 | 1.71 | 2.09 | | |
| | protein 4 | | | | | |
| Q8IUY3 | GRAM domain-containing protein | 2.33 | 2.85 | 1.25 | A | |
| | 2/GRAMD2 | | | | | |
| Q8IUY3 | GRAM domain-containing protein | 6.8 | 6.97 | 1.06 | A | |
| | 2/GRAMD2 | | | | | |
| Q8IUY3 | GRAM domain-containing protein | 3.81 | 3.47 | −1.06 | A | |
| | 2/GRAMD2 | | | | | |
| P04792 | Heat shock protein beta-1/HSP27 | 3.43 | −1.5 | −5.02 | | K |
| P04792 | Heat shock protein beta-1/HSP27 | 2.39 | −2.82 | −6.57 | | K |
| P29218 | Inositol monophosphatase | −2.41 | 1.1 | 2.72 | | K |
| P22692 | Insulin-like growth factor-binding | 6.64 | 29.51 | 4.56 | | K |
| | protein 4/IGFBP4 | | | | | |
| P22692 | Insulin-like growth factor-binding | 8.64 | 25.19 | 2.99 | | K |
| | protein 4/IGFBP4 | | | | | |
| O14879 | Interferon-induced protein with | −9.31 | −7.91 | 1.22 | A | |
| | tetratricopeptide repeats 3/IFIT3/ | | | | | |
| | ISG60 | | | | | |
| P30740 | Leukocyte elastase inhibitor/ | −4.73 | −3.25 | 1.49 | | K |
| | Serpin B1 | | | | | |
| Q14168 | MAGUK p55 subfamily member | 2.66 | 13.13 | 5.06 | | |
| | 2/MPP2 | | | | | |
| Q14168 | MAGUK p55 subfamily member | 1.31 | 2.53 | 1.98 | | |
| | 2/MPP2 | | | | | |
| P35240 | Merlin/Neurofibromin-2 | 4.77 | 1.54 | −3.03 | | |
| P26038 | Moesin | −3 | 1.95 | 6.04 | | K |
| O75380 | NADH dehydrogenase | 2.09 | 2.16 | 1.07 | | |
| | [ubiquinone] iron-sulfur protein 6 | | | | | |
| P62937 | Peptidyl-prolyl cis-trans isomerase | −1.88 | −1.2 | 1.61 | | K |
| | A/cyclophilin A | | | | | |
| Q06830 | Peroxiredoxin-1 | 2.11 | 1.29 | −1.6 | | K |
| P32119 | Peroxiredoxin-2 | 2.06 | 1.84 | −1.09 | | K |
| P30086 | Phosphatidylethanolamine-binding | 1.52 | 1.26 | −1.17 | | K |
| | protein 1/PEBP1/Raf kinase | | | | | |
| | inhibitor protein | | | | | |
| P18669 | Phosphoglycerate mutase 1 | −1.2 | 4.81 | 5.9 | B | |
| Q01814 | Plasma membrane | −2.96 | −6.05 | −1.99 | | |
| | calcium-transporting ATPase 2/ | | | | | |
| | PMCA2/ATP2B2/Plasma | | | | | |
| | membrane calcium ATPase | | | | | |
| | isoform 2 | | | | | |
| P05121 | Plasminogen activator inhibitor 1/ | −10.93 | −8.8 | 1.29 | | K |
| | PAI1/SERPINE1 | | | | | |
| P25786 | Proteasome subunit alpha type-1 | −1.05 | 1.56 | 1.68 | A | |
| P25787 | Proteasome subunit alpha type-2 | −1.49 | 1.05 | 1.61 | | K |
| P49720 | Proteasome subunit beta type-3 | −1.45 | 1.03 | 1.52 | A | |
| P31150 | Rab GDP dissociation inhibitor | 12.45 | 7.78 | −1.55 | | K |
| | alpha/GDI1 | | | | | |
| P50395 | Rab GDP dissociation inhibitor | 1.21 | 1.68 | 1.44 | | K |
| | beta/GDI2 | | | | | |
| Q9H5N1 | Rab GTPase-binding effector | −15.11 | −8.81 | 1.78 | A | |
| | protein 2 | | | | | |
| Q8WUD1 | Ras-related protein Rab-2B | 1.2 | −1.77 | −2.07 | A | |
| Q13228 | Selenium-binding protein 1/ | 1.38 | −1.52 | −2.03 | B | |
| | SELENBP1 | | | | | |
| P36952 | Serpin B5 | −16.8 | −21.59 | −1.25 | | |
| P04179 | Superoxide dismutase [Mn], | −4.36 | −1.72 | 2.6 | | |
| | mitochondrial | | | | | |
| P55072 | Transitional endoplasmic | −1.31 | 1.36 | 1.85 | | K |
| | reticulum ATPase/ | | | | | |
| | Valosin-containing protein/VCP | | | | | |
| Q8N912 | Transmembrane protein | 1.88 | 1.91 | 1.05 | A | |
| | C14orf180 | | | | | |
| Q9P1Q0 | Vacuolar protein | −18.84 | −25.44 | −1.31 | A | |
| | sorting-associated protein 54/ | | | | | |
| | Hepatocellular carcinoma protein | | | | | |
| | 8/Tumor antigen SLP-8p/ | | | | | |
| | VPS54 | | | | | |
| O75083 | WD repeat-containing protein 1/ | −1.26 | 1.76 | 2.3 | | K |
| | Actin-interacting protein 1 | | | | | |

^{#}The everage ratio of differentially expressed (p < 0.05) proteins after 2D-DIGE analysis across MCF-10A, MCF-7, and MDA-MB-231 were calculated considering 3 replica gels.
^{##}Identified protiens which have not been reported in any cancer research are marked “A”, while proteins which have been reported in cancer research but not in breast cancer research are marked “B”.
^{###}Poreins in this list have been reported in Kulasing et al's experiment.

TABLE 1b
Alphabetical list of identified differentially expressed secreted
proteins obtained after MALTI-TOF mass spectrometry analysis.

| Accession | | | No. Match. | seq cov | | Subcellular | |
|---|---|---|---|---|---|---|---|
| code | pI | MW | Peptides | (%) | Score | location* | functional class* |
| P63104 | 4.73 | 27899 | 17/43 | 52 | 137/56 | Cytoplasm | Siganl transduction |
| O95861 | 5.46 | 33713 | 8/12 | 27 | 76/56 | Cytoplasm | Biosynthesis |
| O95336 | 5.7 | 27815 | 9/44 | 41 | 60/56 | Cytoplasm | Metabolism |
| P60709 | 5.29 | 42052 | 7/12 | 23 | 65/56 | Cytoplasm | Cytoskeleton |
| P60709 | 5.29 | 42052 | 7/15 | 22 | 65/56 | Cytoplasm | Cytoskeleton |
| P15121 | 6.51 | 36230 | 7/24 | 25 | 57/56 | Cytoplasm | Metabolism |
| P06733 | 7.01 | 47481 | 10/20 | 26 | 70/56 | Cytoplasm | Metabolism |
| P08758 | 4.94 | 35971 | 10/17 | 26 | 77/56 | Plasma membrane | Signal transduction/Ca |
| | | | | | | | regulation |
| Q8N1M1 | 6.13 | 76457 | 9/22 | 14 | 66/56 | Plasma membrane | Transport/channel |
| P00918 | 6.87 | 29285 | 7/31 | 29 | 62/56 | Cytoplasm | Metabolism |
| P46527 | 6.54 | 22288 | 6/28 | 32 | 83/56 | Nucleus | Cell cycle |
| Q9C0G6 | 5.72 | 479761 | 19/31 | 5 | 66/56 | Cytoplasm | Cytoskeleton |
| Q9NPC3 | 8.59 | 31923 | 6/23 | 24 | 60/56 | Nucleus | Cell cycle |
| Q93070 | 9.31 | 36197 | 5/49 | 15 | 57/56 | Plasma membrane | Biosynthesis |
| P04075 | 8.3 | 39851 | 15/35 | 47 | 103/56 | Cytoplasm | Metabolism |
| P21266 | 5.37 | 26998 | 7/11 | 25 | 58/56 | Cytoplasm | Redox regulation |
| P09211 | 5.43 | 23569 | 6/15 | 38 | 56/56 | Cytoplasm | Redox regulation |
| P09211 | 5.43 | 23569 | 7/15 | 41 | 73/56 | Cytoplasm | Redox regulation |
| P04406 | 8.57 | 36201 | 6/17 | 20 | 59/56 | Mito | Metabolism |
| Q9HC38 | 5.4 | 35170 | 6/15 | 20 | 58/56 | Mito | Redox regulation |
| Q8IUY3 | 8.73 | 40908 | 6/26 | 13 | 60/56 | Plasma membrane | Unknown |
| Q8IUY3 | 8.73 | 40908 | 9/56 | 25 | 63/56 | Plasma membrane | Unknown |
| Q8IUY3 | 8.73 | 40908 | 7/29 | 19 | 61/56 | Plasma membrane | Unknown |
| P04792 | 5.98 | 22826 | 4/26 | 25 | 69/56 | Cytoplasm | Protein folding |
| P04792 | 5.98 | 22826 | 6/14 | 30 | 72/56 | Cytoplasm | Protein folding |
| P29218 | 5.16 | 30568 | 6/32 | 23 | 64/56 | Cytoplasm | Biosynthesis |
| P22692 | 6.81 | 29113 | 10/42 | 37 | 123/56 | Secreted | Siganl transduction |
| P22692 | 6.81 | 29113 | 8/23 | 28 | 105/56 | Secreted | Siganl transduction |
| O14879 | 5.12 | 56691 | 6/16 | 16 | 66/56 | Plasma membrane | Siganl transduction |
| P30740 | 5.9 | 42829 | 14/34 | 33 | 126/56 | Cytoplasm | Protease inhibitor |
| Q14168 | 6.28 | 64887 | 7/24 | 14 | 60/56 | Plasma membrane | Siganl transduction |
| Q14168 | 6.28 | 64887 | 7/24 | 14 | 57/56 | Plasma membrane | Siganl transduction |
| P35240 | 6.11 | 69874 | 10/29 | 15 | 70/56 | Plasma membrane | Cell motility/signal |
| | | | | | | | transduction |
| P26038 | 6.08 | 67892 | 14/34 | 19 | 96/56 | Plasma membrane | Cell motility/ |
| | | | | | | | cytoskeleton |
| O75380 | 8.59 | 14045 | 6/52 | 33 | 58/56 | Mito | Electron transport |
| P62937 | 7.68 | 18229 | 10/25 | 64 | 112/56 | Cytoplasm | Protein folding |
| Q06830 | 8.27 | 22324 | 13/33 | 56 | 139/56 | Cytoplasm | Redox Regulation |
| P32119 | 5.66 | 22049 | 6/24 | 35 | 75/56 | Cytoplasm | Redox Regulation |
| P30086 | 7.01 | 21158 | 8/33 | 54 | 97/56 | Cytoplasm | Siganl transduction |
| P18669 | 6.67 | 28900 | 8/27 | 35 | 70/56 | Cytoplasm | Metabolism |
| Q01814 | 5.66 | 137987 | 7/16 | 7 | 71/56 | Plasma membrane | Transport |
| P05121 | 6.68 | 45088 | 8/14 | 14 | 72/56 | Secreted | Protease inhibitor |
| P25786 | 6.15 | 29822 | 6/26 | 23 | 58/56 | Proteasome | Proteins degradation |
| P25787 | 6.92 | 255996 | 6/22 | 33 | 70/56 | Proteasome | Proteins degradation |
| P49720 | 6.14 | 23219 | 7/20 | 38 | 67/56 | Proteasome | Proteins degradation |
| P31150 | 5 | 51177 | 8/32 | 25 | 65/56 | Plasma membrane | Siganl transduction |
| P50395 | 6.11 | 51087 | 5/38 | 18 | 58/56 | Plasma membrane | Siganl transduction |
| Q9H5N1 | 4.76 | 63690 | 8/26 | 13 | 62/56 | Plasma membrane | Membrane trafficking |
| Q8WUD1 | 7.68 | 24427 | 5/20 | 25 | 68/56 | Plasma membrane | Siganl transduction |
| Q13228 | 5.93 | 52928 | 11/23 | 20 | 94/56 | Plasma membrane | Transport |
| P36952 | 5.72 | 42568 | 6/22 | 18 | 61/56 | Secreted | Protease inhibitor |
| P04179 | 8.35 | 24878 | 6/27 | 30 | 65/56 | Mito | Redox Regulation |
| P55072 | 5.14 | 899550 | 25/41 | 34 | 197/56 | Cytoplasma | Vascular transport |
| Q8N912 | 11.2 | 18382 | 4/38 | 25 | 58/56 | Plasma membrane | Unknown |
| Q9P1Q0 | 6.1 | 111545 | 7/24 | 11 | 64/56 | Endosome | Vascular transport |
| O75083 | 6.17 | 66836 | 18/32 | 40 | 197/56 | Cytoplasm | Cytoskeleton |

*The subcellular locations and functional classes of identified proteins were obtained from the Uniprot website.

### EXAMPLE 7

### DIGE and MALDI-TOF Analyses of the Total Cell Proteomes Among MCF-10A, MCF-7 and MDA-MB-231 Cells

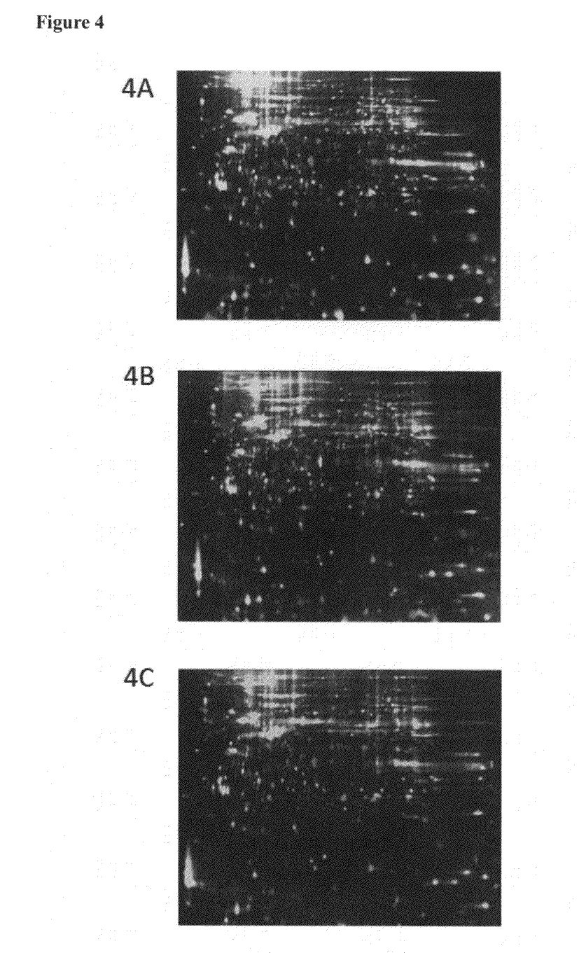

To identify the altered abundances of proteins and relate them to the tumorigenesis of breast cancer, the proteomic profiles of MCF-10A, MCF-7 and MDA-MB-231 were analyzed. Triplicates of the three different cell lysates were compared using 2D-DIGE to obtain an overview of breast cell tumorigenesis. Image analysis using DeCyder v7.0 clearly defined more than 2500 protein spots (FIG. 4). To reduce the intrinsic variability derived from protein samples and gel-to-gel variation, only those protein spots that appeared in all of the triplicate gel images were used for statistical analysis.

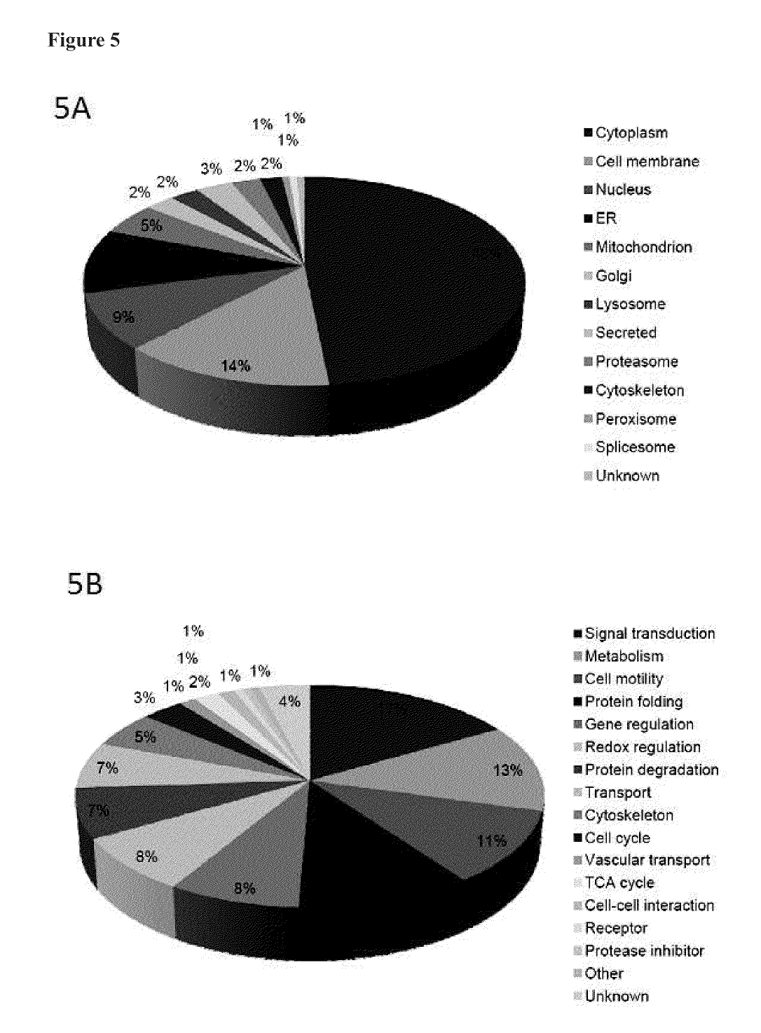

Furthermore, biological variation analysis of spots showing greater than 1.5-fold change in expression with a t-test score of less than 0.05 were visually checked before confirming the alterations for protein identification. MALDI-TOF MS identification revealed 133 unique differentially expressed proteins across MCF-10A, MCF-7, and MDA-MB-231 (Table 2). Of the 133 proteins identified, 107 of them had differential expressions between MCF-7/MCF-10A, 63 were differentially expressed between MDA-MB-231/MCF-10A and 96 had differential expressions between MDA-MB-231 and MCF-7. Almost half of the total proteins identified in this breast cell model were cytosolic proteins (FIG. 5A), and most of the identified proteins were involved in signaling transduction, metabolism, protein folding, and cell motility (FIG. 5B). According to the comparison table, 51 of these identified spots, including Calumenin, have not been reported in any breast cancer related studies. As such, these proteins might have the potential to be putative breast cancer markers. As expected, some well-known breast cancer markers, such as 14-3-3 proteins, annexins, calmodulin, AGR-2, Galectin-1 and ROCK2, were also identified in this 2D-DIGE experiment, lending credence to the reliability of early phase biomarker detection using this experimental strategy. In a previous study, Nagaraja et.al. used traditional 2-DE with post-stains (silver stain and coomassie blue stain) to reveal 26 differentially expressed proteins among transformed breast cells with different levels of invasiveness and normal cells which were the same cell lines used in the present study (Nagaraja, G. M.; Othman, M.; Fox, B. P.; Alsaber, R.; Pellegrino, C. M.; Zeng, Y.; Khanna, R.; Tamburini, P.; Swaroop, A.; Kandpal, R. P. Oncogene 2006, 25, 2328). Their study showed no evidence of visualizing protein spots with sensitive strategies, and protein expression changes were not quantifiable because no broader linear-ranged methods and statistical analysis were employed. Only 6 out of those 26 proteins coincide with statistical 2D-DIGE data of the present invention, which implies that differences might have derived from artificial variations or from results with no statistical analysis (Table 2).

TABLE 2
Alphabetical list of identified differentially expressed total
cellular proteins across MCF-10A, MCF-7 and MDA-MB-231 breast
cells.

| | | | | | | Reported |
|---|---|---|---|---|---|---|
| | | | | | Putative | by |
| Accession | | MCF7/ | MDA231/ | MDA231/ | Breast | Nagaraja |
| Code | Protein name | MCF10A^{#} | MCF10A^{#} | MCF7^{#} | Markers^{##} | et al^{###} |
| P62258 | 14-3-3 protein epsilon | −3.37 | 1.3 | 4.55 | | |
| P63104 | 14-3-3 protein zeta/delta | −1.95 | 1.13 | 2.26 | | |
| P61254 | 60S ribosomal protein L26 | 9.72 | −2.69 | −22.09 | | |
| P11021 | 78 kDa glucose-regulated protein | 1.73 | −1.63 | −2.59 | | |
| Q6XD76 | Achaete-scute homolog 4/ASCL4 | 1.18 | 1.74 | 1.47 | B | |
| P21399 | Aconitate hydratase | 1.24 | 1.62 | 1.31 | A | |
| Q9Y6K8 | Adenylate kinase isoenzyme 5 | −2.07 | −1.07 | 2.01 | | |
| O95994 | AGR2/Anterior gradient protein 2 homolog | 31.03 | 1.75 | −15 | | |
| P15121 | Aldose reductase | −1.18 | 2.3 | 2.73 | | |
| P06733 | Alpha-enolase | 1.3 | 1.62 | 1.24 | | |
| Q9H4A4 | Aminopeptidase B | −1.56 | −2.43 | −1.55 | B | |
| P04083 | Annexin A1 | −3.96 | −1.03 | 3.97 | | |
| P07355 | Annexin A2 | −5.67 | −2.37 | 2.47 | | |
| P07355 | Annexin A2 | −8.1 | −3.56 | 2.35 | | |
| P12429 | Annexin A3 | 1.61 | −3.86 | −6.21 | B | |
| P09525 | Annexin A4 | −1.39 | −3.91 | −2.82 | | |
| P09525 | Annexin A4 | −1.1 | −4.59 | −4.19 | | |
| P08758 | Annexin A5 | −2.84 | 1.65 | 4.83 | | |
| P08758 | Annexin A5 | −1.81 | −1.11 | 1.63 | | |
| P08133 | Annexin A6 | 2.28 | 1.39 | −1.64 | | |
| P14868 | Aspartyl-tRNA synthetase | −3.18 | −3.65 | −1.15 | | |
| P06576 | ATP synthase subunit beta | −1.26 | −1.66 | −1.32 | | |
| O75531 | Barrier-to-autointegration factor/Breakpoint | 3.09 | −3.18 | −9.49 | A | |
| | cluster region protein 1 | | | | | |
| P31939 | Bifunctional purine biosynthesis protein PURH/ | 2.37 | 1.14 | −2.08 | A | |
| | IMP cyclohydrolase/ATIC | | | | | |
| P62158 | Calmodulin | 2.92 | −2.15 | −6.08 | | |
| P62158 | Calmodulin | 3.85 | −2.6 | −9.67 | | |
| P04632 | Calpain small subunit 1/Capn4/ | −1.59 | −1.55 | 1.02 | | |
| | Calcium-dependent protease small subunit/ | | | | | |
| | Calpain regulatory subunit | | | | | |
| P27797 | Calreticulin | 2.16 | −1.36 | −2.84 | | N |
| O43852 | Calumenin | 2.03 | −1.16 | −2.26 | B | |
| P00918 | Carbonic anhydrase 2 | −1.54 | −9.13 | −5.94 | B | |
| P07339 | Cathepsin D | 8.45 | −2.1 | −17.7 | | |
| P07339 | Cathepsin D | 9.91 | −9.22 | −40.11 | | |
| P07339 | Cathepsin D | 5.19 | −1.48 | −53.69 | | |
| P07339 | Cathepsin D | 7.8 | −5.32 | −88.32 | | |
| P29373 | Cellular retinoic acid-binding protein 2/ | 2.37 | −5.13 | −12.14 | | |
| | CRABP2 | | | | | |
| O00299 | Chloride intracellular channel protein 1/CLIC1 | −1.14 | 1.6 | 1.82 | | |
| O00299 | Chloride intracellular channel protein 1/CLIC1 | −1.13 | 1.37 | 1.55 | | |
| Q9Y696 | Chloride intracellular channel protein 4/CLIC4 | −5.72 | −2.25 | 2.54 | | |
| Q9Y696 | Chloride intracellular channel protein 4/CLIC4 | −4.09 | −1.87 | 2.19 | | |
| O75390 | Citrate synthase | −2.09 | −2.68 | −1.24 | | |
| O14579 | Coatomer subunit epsilon (COPE) | 2.17 | 1.13 | −1.86 | | |
| P23528 | Cofilin-1 | 1.33 | −3.8 | −5.06 | | |
| A6NKD9 | Coiled-coil domain-containing protein/ | 5.12 | 6.54 | 1.28 | A | |
| | CCDC85C | | | | | |
| Q14993 | Collagen alpha-1(XIX) chain/Collagen alpha-1 | 3.23 | 3.84 | 1.23 | | |
| Q15828 | Cystatin-M | 2.34 | 1.76 | −1.33 | | |
| Q04695 | Cytokeratin 1 | 1.54 | 1.34 | −1.15 | | |
| P19012 | Cytokeratin 15 | −6.26 | −11.21 | −1.73 | | |
| P05787 | Cytokeratin 8 | 17.75 | 1.67 | −10.66 | | |
| Q9UBS4 | DnaJ homolog subfamily B member 11 | 2.28 | −1.06 | −2.34 | | |
| P29692 | Elongation factor 1-delta | 1.29 | 1.56 | 1.21 | | |
| P26641 | Elongation factor 1-gamma | 1.74 | 1.85 | 1.06 | | |
| P13639 | Elongation factor 2 | 1.62 | 1.11 | −1.46 | | |
| P30040 | Endoplasmic reticulum protein ERp29 | 4.31 | 1.23 | −2.92 | | |
| P30040 | Endoplasmic reticulum protein ERp29 | 4.89 | 1.62 | −3.39 | | |
| P14625 | Endoplasmin | 2.41 | 1.08 | −1.89 | | |
| O94905 | Erlin-2/SPFH 2 | 1.94 | −1.53 | −2.87 | A | |
| P63241 | Eukaryotic translation initiation factor 5A-1 | −1.69 | 1.28 | 2.53 | | |
| P63241 | Eukaryotic translation initiation factor 5A-1 | −2.54 | −1.04 | 2.23 | | |
| P47756 | F-actin-capping protein subunit beta | 1.53 | −1.38 | −2.1 | B | |
| P47756 | F-actin-capping protein subunit beta | 1.2 | −1.81 | −2.18 | B | |
| Q02790 | FK506-binding protein 4/Peptidyl-prolyl | 2.83 | −1.07 | −3.03 | | |
| | cis-trans isomerase/FKBP52 | | | | | |
| P30043 | Flavin reductase | 11.67 | 5.46 | −2.14 | B | |
| P09467 | Fructose-1,6-bisphosphatase 1 | 4.57 | 1.19 | −3.83 | A | |
| P09467 | Fructose-1,6-bisphosphatase 1 | 12.62 | −1.12 | −14.19 | A | |
| P04075 | Fructose-bisphosphate aldolase A | 1.66 | −1.31 | −2.18 | B | |
| P04075 | Fructose-bisphosphate aldolase A | 1.8 | −1.29 | −2.32 | B | |
| P09382 | Galectin-1 | 5.99 | −1.18 | −6.83 | | N |
| P11413 | Glucose-6-phosphate 1-dehydrogenase/G6PD | 4.39 | −1.05 | −4.62 | | |
| P14314 | Glucosidase 2 subunit beta/PRKCSH/80K-H | 2.91 | −1.05 | −2.96 | | |
| | protein | | | | | |
| P21266 | Glutathione S-transferase Mu 3 | 16.67 | 2.54 | −6.57 | | |
| P21266 | Glutathione S-transferase Mu3 | 46.76 | 2.56 | −18.29 | | |
| P09211 | Glutathione S-transferase P | −27.61 | −11.61 | 2.38 | | |
| P09211 | Glutathione S-transferase P | −17.35 | −8.71 | 2.06 | | |
| P62993 | Growth factor receptor-bound protein 2 (Grb2) | 3.19 | 1.63 | −1.96 | | |
| Q12931 | Heat shock protein 75 kDa/TNFR-associated | 1.83 | −1.09 | −1.99 | B | |
| | protein 1/TRAP1 | | | | | |
| P04792 | Heat shock protein beta-1/HSP 27 | 4.22 | −4.51 | −19.01 | | N |
| P04792 | Heat shock protein beta-1/HSP 27 | 7.97 | −3.26 | −25.98 | | N |
| P04792 | Heat shock protein beta-1/HSP 27 | 7.62 | −3.7 | −28.21 | | N |
| P68871 | Hemoglobin subunit beta | 2.9 | 2.44 | −1.15 | | |
| P61978 | Heterogeneous nuclear ribonucleoprotein K | −2.66 | −2.36 | 1.17 | | |
| P22626 | Heterogeneous nuclear ribonucleoproteins | −2.74 | −2.52 | 1.13 | B | |
| | A2/B1 | | | | | |
| Q13547 | Histone deacetylase 1 | 12.52 | 11.23 | −1.08 | | |
| Q9Y4L1 | Hypoxia up-regulated protein 1 | 2.05 | −1.12 | −1.94 | | |
| Q04760 | Lactoylglutathione lyase/Glyoxalase 1/ | 1.52 | 1.64 | 1.08 | | |
| | Aldoketomutase | | | | | |
| P09960 | Leukotriene A-4 hydrolase/LTA4H | −1.6 | −1.28 | 1.25 | B | |
| P07195 | L-lactate dehydrogenase B chain | −7.5 | −1.09 | 6.89 | | |
| P07195 | L-lactate dehydrogenase B chain | −3.25 | −1.09 | 2.98 | | |
| P40926 | Malate dehydrogenase | 1.32 | −1.92 | −2.53 | | |
| O00264 | Membrane-associated progesterone receptor | 3.27 | −1.43 | −4.51 | | |
| | component 1/PGRMC1 | | | | | |
| O75121 | Microfibrillar-associated protein 3 like/ | −1.58 | 9.38 | 14.78 | B | |
| | MFAP3L | | | | | |
| Q15691 | Microtubule-associated protein RP/EB family | −1.36 | 1.44 | 1.97 | B | |
| | member 1 (End-binding protein 1) | | | | | |
| P26038 | Moesin | −2.33 | 3.51 | 8.46 | | |
| P60660 | Myosin light polypeptide 6 | 5.49 | −1.79 | −9.48 | | |
| O14950 | Myosin regulatory light chain MRLC2 | 1.84 | 1.8 | 1.16 | | |
| P19105 | Myosin regulatory light chain MRLC3 | −3.9 | −1.93 | 2.09 | | |
| P30084 | Myosin-IXa | −1.03 | −2.08 | −1.95 | | |
| Q14697 | Neutral alpha-glucosidase AB/Glucosidase II | 2.34 | −1.22 | −2.32 | | |
| | subunit alpha | | | | | |
| Q14697 | Neutral alpha-glucosidase AB/Glucosidase II | 1.87 | −1.28 | −2.75 | | |
| | subunit alpha | | | | | |
| Q9NXR1 | Nuclear distribution protein nudE homolog 1/ | 7.78 | 6.44 | −1.17 | A | |
| | NDE1 | | | | | |
| P15531 | Nucleoside diphosphate kinase A/NDP kinase A | −1.85 | 1.07 | 2.04 | | N |
| P20472 | Parvalbumin alpha | 16.77 | 10.64 | −1.52 | B | |
| O00151 | PDZ and LIM domain protein 1/LIM domain | −3.96 | −1.46 | 2.8 | B | |
| | protein CLP-36/Elfin/CLP36 | | | | | |
| P62937 | Peptidyl-prolyl cis-trans isomerase A/ | −1.34 | −1.65 | −1.24 | | N |
| | cyclophilin A | | | | | |
| P62937 | Peptidyl-prolyl cis-trans isomerase A/ | −1.41 | −1.76 | −1.25 | | N |
| | cyclophilin A | | | | | |
| Q96BP3 | Peptidylprolyl isomerase domain and WD | −4.68 | −3.06 | 1.58 | A | |
| | repeat-containing protein 1 | | | | | |
| Q13162 | Peroxiredoxin-4 | 1.74 | 1.19 | −1.46 | | |
| Q13162 | Peroxiredoxin-4 | 4.92 | −1.11 | −5.29 | | |
| P30041 | Peroxiredoxin-6 | 1.4 | −1.23 | −1.73 | | |
| P30041 | Peroxiredoxin-6 | 1.09 | −1.67 | −1.82 | | |
| Q9Y617 | Phosphoserine aminotransferase/PSAT | −5.37 | −1.26 | 4.25 | B | |
| P13797 | Plastin-3/T plastin | −3.88 | −1.67 | 2.32 | A | |
| P07737 | Profilin-1 | −1.35 | 1.2 | 1.62 | | |
| P07737 | Profilin-1 | −1.29 | 1.16 | 1.5 | | |
| Q8WUM4 | Programmed cell death 6-interacting protein/ | 1.88 | −1.07 | −2.02 | B | |
| | ALG-2-interacting protein 1/Hp95/PDCD6IP | | | | | |
| P35232 | Prohibitin | 1.08 | 1.63 | 1.51 | | |
| Q15185 | Prostaglandin E synthase 3/PGES | 1.63 | 1.18 | −1.38 | | |
| Q06323 | Proteasome activator complex subunit 1 | 1.73 | −1.3 | −2.24 | A | |
| Q9UL46 | Proteasome activator complex subunit 2 | 1.36 | −1.22 | −1.66 | B | |
| Q9UL46 | Proteasome activator complex subunit 2 | 1.58 | −1.25 | −1.98 | B | |
| | (PSME2) | | | | | |
| P61289 | Proteasome activator complex subunit 3 | −1.11 | 1.48 | 1.64 | | |
| | (PSME3) | | | | | |
| Q9Y2B0 | Protein canopy homolog 2/CNPY2/ | 1.85 | −3.25 | −5.82 | A | |
| | MIR-interacting saposin-like protein | | | | | |
| Q6XLA1 | Protein CASC2, isoform 3/Cancer | −2.97 | 1.09 | 3.34 | B | |
| | susceptibility candidate gene 2 protein, isoform 3 | | | | | |
| P07237 | Protein disulfide-isomerase A1/PDI | 3.33 | −1.75 | −5.63 | | |
| P30101 | Protein disulfide-isomerase A3/ERp57 | −2 | −1.41 | 1.42 | | |
| Q15084 | Protein disulfide-isomerase A6/PDIA6/ | −1.12 | −1.66 | −1.49 | A | |
| | Protein disulfide isomerase P5 | | | | | |
| Q9HCY8 | Protein S100A14 | −5.11 | −6.92 | −1.31 | | |
| Q6PI26 | Protein SHQ1 | −1.27 | −4.27 | −3.36 | A | |
| P14618 | Pyruvate kinase isozymes M1/M2/Pyruvate | −1.77 | −1.54 | 1.15 | | |
| | kinase 2/3/ | | | | | |
| | PKM2/THBP1 | | | | | |
| P50395 | Rab GDP dissociation inhibitor beta/GDI2 | 1.53 | 1.19 | −1.29 | B | |
| Q8WUD1 | Ras-related protein Rab-2B | −5.45 | −13.37 | −2.07 | A | |
| Q14257 | Reticulocalbin-2/ERC-55/RCN2 | 1.5 | −1.78 | −2.59 | B | |
| O94788 | Retinal dehydrogenase 2/Aldehyde | 6.02 | −1.12 | −6.51 | | |
| | dehydrogenase family 1 member A2/ | | | | | |
| | ALDH1A2 | | | | | |
| P42331 | Rho GTPase-activating protein 25 | 1.54 | 1.11 | −1.17 | A | |
| Q13017 | Rho GTPase-activating protein 5/p190-B/ | 1.93 | 1.31 | −1.47 | B | |
| | ARHGAP5/RhoGAP 5 | | | | | |
| O75116 | Rho-associated protein kinase 2/ROCK2 | 5.16 | −1.56 | −8.07 | | |
| O75116 | Rho-associated protein kinase 2/ROCK2 | 8.04 | −2.56 | −20.57 | | |
| P13489 | Ribonuclease inhibitor/RNase inhibitor | −1.54 | −1.68 | −1.09 | A | |
| Q13228 | Selenium-binding protein 1/SELENBP1 | 3.04 | −1.1 | −3.34 | B | |
| Q13228 | Selenium-binding protein 1/SELENBP1 | 6.76 | −1.12 | −7.56 | B | |
| Q9NVA2 | Septin-11 | 2.15 | −1.9 | −3.98 | A | |
| Q92599 | Septin-8 | 2.36 | 1.05 | −2.17 | A | |
| Q8TDX7 | Serine/threonine-protein kinase Nek7 | −2.14 | −1.53 | 1.66 | A | |
| Q00536 | Serine/threonine-protein kinase PCTAIRE-1 | 4.12 | −1.28 | −5.28 | A | |
| P36952 | Serpin B5 | −10.78 | −11.05 | −1.02 | | |
| P55854 | Small ubiquitin-related modifier 3/SUMO3 | −2.61 | −1.83 | 1.48 | B | |
| P31948 | Stress-induced-phosphoprotein 1/STIP1 | −2.2 | 1.07 | 2.42 | B | |
| Q8NBS9 | Thioredoxin domain-containing protein 5/ | 5.71 | −1.11 | −6.13 | B | |
| | ERp46/TXNDC5 | | | | | |
| Q8NBS9 | Thioredoxin domain-containing protein 5/ | 5.8 | −1.53 | −8.61 | B | |
| | ERp46/TXNDC5 | | | | | |
| Q9UI15 | Transgelin-3 | 5.15 | 2.84 | −1.53 | | |
| P60174 | Triosephosphate isomerase/TPI | 1.61 | −1.05 | −1.68 | | N |
| P60174 | Triosephosphate isomerase/TPI | 1.5 | −1.45 | −2.18 | | |
| P67936 | Tropomyosin alpha-4 chain/Tropomyosin-4 | −1.72 | 1.38 | 2.46 | | |
| P61088 | Ubiquitin-conjugating enzyme E2/Ubc13 | −2.28 | 1.29 | 3.04 | A | |
| Q5VYV7 | UPF0492 protein C20orf94 | −4.17 | −2.6 | 1.66 | A | |
| P08670 | Vimentin | −3.55 | 4.14 | 15.21 | | |
| P08670 | Vimentin | −3.77 | 2.65 | 10.32 | | |
| P21796 | Voltage-dependent anion-selective channel | −1.65 | −2.13 | −1.29 | B | |
| | protein 1/VDAC1 | | | | | |
| P45880 | Voltage-dependent anion-selective channel | −1.55 | −1.62 | −1.05 | B | |
| | protein 2/VDAC2 | | | | | |
| Q2VY69 | Zinc finger protein 284 | −8.32 | −2.7 | 3.19 | | |
| Q8N7K0 | Zinc finger protein 433 | 7.92 | −1.02 | −8.04 | B | |
| Q6ZNA1 | Zinc finger protein 836 | 2.2 | 1.21 | −1.53 | | |

^{#}The everage ratio of differentially expressed (p < 0.05) proteins after 2D-DIGE analysis
across MCF-10A, MCF-7, and MDA-MB-231 were calculated considering 3 replica gels.
^{##}Identified protiens which have not been reported in any cancer research are marked
“A”, while proteins which have been reported in cancer research but not in breast cancer
research are marked “B”.
^{###}Poreins in this list have been reported in Nagaraja et al's experiment.

Alphabetical list of identified differentially expressed total
cellular proteins obtained after MALDI-TOF mass spectrometry
analysis.

| Accession | | | No. Match. | seq cov | | Subcellular | |
|---|---|---|---|---|---|---|---|
| Code | pI | MW | Peptides | (%) | Score | location | functional class* |
| P62258 | 4.63 | 29326 | 8 | 20% | 67/56 | Cytoplasma | Sgnal Transduction |
| P63104 | 4.73 | 27899 | 8 | 28% | 74/56 | Cytoplasma | Sgnal Transduction |
| P61254 | 10.55 | 17248 | 6 | 31% | 56/56 | Cytoplasma | Biosynthesis |
| P11021 | 5.07 | 72402 | 11 | 20% | 98/56 | ER | Biosynthesis |
| Q6XD76 | 9.23 | 19469 | 4 | 31% | 59/56 | Nucleus | Gene Regulation |
| P21399 | 6.23 | 98850 | 10 | 15% | 92/56 | Mito | TCA cycle |
| Q9Y6K8 | 5.38 | 22358 | 5 | 35% | 63/56 | Cytoplasma | Sgnal Transduction |
| O95994 | 9.03 | 20024 | 5 | 34% | 63/56 | Secreted | Unknown |
| P15121 | 6.51 | 36230 | 7 | 33% | 82/56 | Cytoplasma | Metabolism |
| P06733 | 7.01 | 47481 | 16 | 47% | 151/56 | Cytoplasma | Metabolism |
| Q9H4A4 | 5.51 | 73234 | 10 | 20% | 98/56 | Secreted | Protein catabolism |
| P04083 | 6.57 | 38918 | 9 | 33% | 105/56 | Cell Membrane | Signal transduction/ |
| | | | | | | | Ca regulation |
| P07355 | 7.57 | 38808 | 10 | 34% | 92/56 | Cell Membrane | Signal transduction/ |
| | | | | | | | Ca regulation |
| P07355 | 7.57 | 38808 | 14 | 41% | 158/56 | Cell Membrane | Signal transduction/ |
| | | | | | | | Ca regulation |
| P12429 | 5.63 | 36524 | 16 | 45% | 151/56 | Cytoplasma | Signal transduction/ |
| | | | | | | | Ca regulation |
| P09525 | 5.84 | 36088 | 6 | 26% | 61/56 | Cell Membrane | Signal transduction/ |
| | | | | | | | Ca regulation |
| P09525 | 5.84 | 36088 | 10 | 34% | 109/56 | Cell Membrane | Signal transduction/ |
| | | | | | | | Ca regulation |
| P08758 | 4.94 | 35971 | 9 | 35% | 127/56 | Cell Membrane | Signal transduction/ |
| | | | | | | | Ca regulation |
| P08758 | 4.94 | 35971 | 11 | 42% | 142/56 | Cell Membrane | Signal transduction/ |
| | | | | | | | Ca regulation |
| P08133 | 5.42 | 76168 | 12 | 20% | 104/56 | Cell Membrane | Signal transduction/ |
| | | | | | | | Ca regulation |
| P14868 | 6.11 | 57499 | 7 | 21% | 61/56 | Cytoplasma | Biosynthesis |
| P06576 | 5.26 | 56525 | 9 | 23% | 98/56 | Mito | Sgnal Transduction |
| O75531 | 5.81 | 10280 | 6 | 55% | 76/61 | Nucleus | Gene Regulation |
| P31939 | 6.27 | 65089 | 11 | 23% | 78/56 | Cytoplasma | Biosynthesis |
| P62158 | 4.09 | 16827 | 5 | 39% | 81/56 | Cytoplasma | Signal transduction/ |
| | | | | | | | Ca regulation |
| P62158 | 4.09 | 16827 | 5 | 39% | 78/56 | Cytoplasma | Signal transduction/ |
| | | | | | | | Ca regulation |
| P04632 | 5.05 | 28469 | 5 | 28% | 64/56 | Cytoplasma | Signal Transduction/ |
| | | | | | | Cell membrane | Cytoskeleton |
| | | | | | | | remodelling/Ca |
| | | | | | | | regulation |
| P27797 | 4.29 | 48283 | 7 | 16% | 71/56 | ER | Signal transduction/ |
| | | | | | | | Ca regulation |
| O43852 | 4.47 | 37198 | 9 | 35% | 129/56 | ER | Signal transduction/ |
| | | | | | | | Ca regulation |
| P00918 | 6.87 | 29285 | 6 | 26% | 69/56 | Cytoplasma | Metabolism |
| P07339 | 6.1 | 45037 | 5 | 14% | 63/56 | Lysosome | Protein degradation |
| P07339 | 6.1 | 45037 | 5 | 16% | 59/56 | Lysosome | Protein degradation |
| P07339 | 6.1 | 45037 | 6 | 16% | 74/56 | Lysosome | Protein degradation |
| P07339 | 6.1 | 45037 | 7 | 16% | 57/56 | Lysosome | Protein degradation |
| P29373 | 5.42 | 15854 | 6 | 46% | 66/56 | Cytoplasma | Transport |
| O00299 | 5.09 | 27248 | 8 | 43% | 114/56 | Cell Membrane | Transport |
| O00299 | 5.09 | 27248 | 9 | 44% | 98/56 | Cell Membrane | Transport |
| Q9Y696 | 5.45 | 28982 | 6 | 32% | 64/56 | Cell Membrane | Transport |
| Q9Y696 | 5.45 | 28982 | 6 | 26% | 69/56 | Cell Membrane | Transport |
| O75390 | 8.45 | 51908 | 4 | 10% | 58/56 | Mito | TCA cycle |
| O14579 | 4.97 | 34688 | 15 | 50% | 181/56 | Golgi | Vascular transport |
| P23528 | 8.22 | 18719 | 5 | 37% | 56/56 | Cytoplasma | Cell motility/Ca |
| | | | | | | | regulation |
| A6NKD9 | 6.48 | 45467 | 7 | 16% | 58/56 | Cytoplasma | Unknown |
| Q14993 | 8.57 | 115947 | 7 | 9% | 61/56 | Secreted | Cell-cell interaction |
| Q15828 | 8.31 | 16785 | 4 | 34% | 61/56 | Secreted | Other |
| Q04695 | 4.97 | 48361 | 8 | 18% | 68/56 | Cytoplasma | Cytoskeleton |
| P19012 | 4.71 | 49365 | 9 | 25% | 106/56 | Cytoplasma | Cytoskeleton |
| P05787 | 5.52 | 53671 | 14 | 31% | 108/56 | Cytoplasma | Cytoskeleton |
| Q9UBS4 | 5.81 | 40774 | 6 | 19% | 69/56 | ER | Protein folding |
| P29692 | 4.9 | 31217 | 6 | 28% | 84/56 | Cytoplasma | Biosynthesis |
| P26641 | 6.25 | 50429 | 10 | 36% | 124/56 | Cytoplasma | Biosynthesis |
| P13639 | 6.41 | 96246 | 10 | 12% | 67/56 | Cytoplasma | Biosynthesis |
| P30040 | 6.77 | 29032 | 6 | 24% | 69/56 | ER | Protein folding |
| P30040 | 6.77 | 29032 | 7 | 24% | 70/56 | ER | Protein folding |
| P14625 | 4.76 | 92696 | 10 | 10% | 89/56 | ER | Protein folding |
| O94905 | 5.47 | 38044 | 9 | 27% | 111/56 | Cell Membrane | Protein catabolism |
| P63241 | 5.08 | 17049 | 8 | 59% | 109/56 | Nucleus | Biosynthesis |
| P63241 | 5.08 | 17049 | 4 | 50% | 56/56 | Nucleus | Biosynthesis |
| P47756 | 5.36 | 31613 | 9 | 34% | 97/56 | Cytoskeleton | Cell motility |
| P47756 | 5.36 | 31613 | 7 | 27% | 74/56 | Cytoskeleton | Cell motility |
| Q02790 | 5.35 | 52057 | 12 | 26% | 94/56 | Cytoskeleton | Protein folding |
| P30043 | 7.13 | 22219 | 6 | 44% | 82/56 | Cytoplasma | Redox regulation |
| P09467 | 6.54 | 37190 | 12 | 40% | 128/56 | Cytoplasma | Metabolism |
| P09467 | 6.54 | 37190 | 14 | 42% | 123/56 | Cytoplasma | Metabolism |
| P04075 | 8.3 | 39851 | 6 | 28% | 60/56 | Cytoplasma | Metabolism |
| P04075 | 8.3 | 39851 | 6 | 28% | 80/56 | Cytoplasma | Metabolism |
| P09382 | 5.34 | 15048 | 5 | 52% | 82/56 | Cytoplasma | Cell-cell interaction |
| P11413 | 6.39 | 59675 | 13 | 20% | 100/56 | Cytoplasma | Metabolism |
| P14314 | 4.33 | 60357 | 13 | 17% | 87/56 | ER | Metabolism |
| P21266 | 5.37 | 26998 | 8 | 40% | 100/56 | Cytoplasma | Redox regulation |
| P21266 | 5.37 | 26998 | 7 | 37% | 88/56 | Cytoplasma | Redox regulation |
| P09211 | 5.43 | 23569 | 10 | 57% | 123/56 | Cytoplasma | Redox regulation |
| P09211 | 5.43 | 23569 | 5 | 31% | 60/56 | Cytoplasma | Redox regulation |
| P62993 | 5.89 | 25304 | 7 | 26% | 91/56 | Golgi | Sgnal Transduction |
| Q12931 | 8.3 | 80345 | 10 | 18% | 64/56 | Mito | Protein folding/Cell |
| | | | | | | | survival |
| P04792 | 5.98 | 22826 | 9 | 40% | 92/56 | Cytoplasma | Protein folding |
| P04792 | 5.98 | 22826 | 6 | 30% | 68/56 | Cytoplasma | Protein folding |
| P04792 | 5.98 | 22826 | 8 | 36% | 78/56 | Cytoplasma | Protein folding |
| P68871 | 6.75 | 16102 | 6 | 53% | 83/56 | Cytoplasma | Oxygen transport |
| P61978 | 5.39 | 51230 | 5 | 13% | 74/56 | Nucleus | Gene Regulation |
| P22626 | 8.97 | 37464 | 7 | 34% | 85/56 | Nucleus | Gene Regulation |
| Q13547 | 5.31 | 55638 | 7 | 22% | 60/56 | Nucleus | Gene Regulation |
| Q9Y4L1 | 5.16 | 111494 | 11 | 13% | 77/56 | ER | Redox regulation |
| Q04760 | 5.12 | 20992 | 6 | 26% | 67/56 | Cytoplasma | Metabolism |
| P09960 | 5.8 | 69868 | 9 | 19% | 84/56 | Cytoplasma | Metabolism |
| P07195 | 5.71 | 36900 | 6 | 17% | 58/56 | Cytoplasma | Metabolism |
| P07195 | 5.71 | 36900 | 6 | 21% | 64/56 | Cytoplasma | Metabolism |
| P40926 | 8.92 | 35965 | 7 | 26% | 69/56 | Mito | TCA cycle |
| O00264 | 4.56 | 21772 | 4 | 16% | 58/56 | Cell Membrane | Receptor |
| O75121 | 5.13 | 45750 | 7 | 13% | 72/56 | Cell membrane | Unknown |
| Q15691 | 5.02 | 30151 | 9 | 48% | 143/56 | Cytoplasma | Cytoskeleton |
| P26038 | 6.08 | 67892 | 7 | 12% | 73/56 | Cell Membrane | Cytoskeleton |
| P60660 | 4.56 | 17090 | 5 | 30% | 63/56 | Cytoplasma | Cell motility |
| O14950 | 4.71 | 19824 | 5 | 23% | 559/56 | Cytoplasma | Cell motility |
| P19105 | 4.67 | 19839 | 4 | 30% | 67/56 | Cytoplasma | Cell motility |
| P30084 | 4.95 | 294989 | 9 | 5% | 58/56 | Cytoplasma | Cell motility |
| Q14697 | 5.74 | 107263 | 26 | 32% | 233/56 | Golgi | Metabolism |
| Q14697 | 5.74 | 107263 | 16 | 20% | 164/56 | Golgi | Metabolism |
| Q9NXR1 | 5.2 | 38842 | 7 | 21% | 57/56 | Cytoplasma | Cell cycle |
| P15531 | 5.83 | 17309 | 6 | 42% | 89/56 | Cytoplasma | Biosynthesis |
| P20472 | 4.98 | 12051 | 6 | 55% | 62/56 | Nucleus | Cell motility/Ca |
| | | | | | | | regulation |
| O00151 | 6.56 | 36505 | 8 | 27% | 97/56 | Cytoplasma | Cell motility/Ca |
| | | | | | | | regulation |
| P62937 | 7.68 | 18229 | 9 | 53% | 91/56 | Cytoplasma | Protein folding |
| P62937 | 7.68 | 18229 | 6 | 36% | 68/56 | Cytoplasma | Protein folding |
| Q96BP3 | 6.7 | 74098 | 6 | 12% | 68/56 | Splicesome | Protein folding |
| Q13162 | 5.86 | 30749 | 6 | 24% | 58/56 | Cytoplasma | Redox regulation |
| Q13162 | 5.86 | 30749 | 7 | 32% | 80/56 | Cytoplasma | Redox regulation |
| P30041 | 6 | 25133 | 10 | 51% | 116/56 | Cytoplasma | Redox regulation |
| P30041 | 6 | 25133 | 7 | 31% | 98/56 | Cytoplasma | Redox regulation |
| Q9Y617 | 7.56 | 40796 | 6 | 16% | 62/56 | Cytoplasma | Metabolism |
| P13797 | 5.52 | 70904 | 7 | 11% | 62/56 | Cytoplasma | Cytoskeleton |
| P07737 | 8.44 | 15216 | 5 | 47% | 62/56 | Cytoplasma | Cell motility |
| P07737 | 8.44 | 15216 | 5 | 47% | 63/56 | Cytoplasma | Cell motility |
| Q8WUM4 | 6.13 | 96590 | 9 | 14% | 61/56 | Cytoplasma | Vascular transport |
| P35232 | 5.57 | 29843 | 7 | 37% | 82/56 | Mito | Gene Regulation |
| Q15185 | 4.35 | 18971 | 6 | 35% | 71/56 | Cytoplasma | Sgnal Transduction |
| Q06323 | 5.78 | 28876 | 12 | 39% | 98/56 | Proteasome | Protein degradation |
| Q9UL46 | 5.44 | 27515 | 7 | 30% | 67/56 | Proteasome | Protein degradation |
| Q9UL46 | 5.44 | 27515 | 7 | 33% | 83/56 | Proteasome | Protein degradation |
| P61289 | 5.69 | 29602 | 8 | 36% | 72/56 | Proteasome | Protein degradation |
| Q9Y2B0 | 4.81 | 20981 | 10 | 53% | 161/56 | ER | Gene Regulation |
| Q6XLA1 | 8.53 | 12065 | 4 | 21% | 64/56 | Peroxisome | Gene Regulation |
| P07237 | 4.76 | 57480 | 6 | 12% | 66/56 | ER | Protein folding |
| P30101 | 5.98 | 57146 | 10 | 23% | 84/56 | ER | Protein folding |
| Q15084 | 4.95 | 48490 | 7 | 24% | 77/56 | ER | Protein folding |
| Q9HCY8 | 5.16 | 11826 | 5 | 63% | 92/56 | Cytoplasma | Signal transduction/ |
| | | | | | | | Ca regulation |
| Q6PI26 | 4.7 | 65712 | 6 | 14% | 56/56 | Cytoplasma | Unknown |
| P14618 | 7.96 | 58470 | 10 | 23% | 101/56 | Cytoplasma | Metabolism |
| P50395 | 6.11 | 51087 | 15 | 39% | 158/56 | Cell Membrane | Sgnal Transduction |
| Q8WUD1 | 7.68 | 24427 | 5 | 29% | 72/56 | Cell Membrane | Sgnal Transduction |
| Q14257 | 4.26 | 36911 | 6 | 25% | 76/56 | ER | Signal transduction/ |
| | | | | | | | Ca regulation |
| O94788 | 5.79 | 57144 | 7 | 14% | 61/56 | Cytoplasma | Biosynthesis |
| P42331 | 5.83 | 72955 | 6 | 11% | 62/56 | Cell Membrane | Cell motility |
| Q13017 | 6.18 | 173834 | 8 | 6% | 63/56 | Cell Membrane | Cell motility |
| O75116 | 5.75 | 161952 | 9 | 5% | 59/56 | Cytoplasma | Cell motility |
| O75116 | 5.75 | 161952 | 14 | 11% | 66/56 | Cytoplasma | Cell motility |
| P13489 | 4.71 | 51766 | 9 | 30% | 115/56 | Cytoplasma | Sgnal Transduction |
| Q13228 | 5.93 | 52928 | 8 | 15% | 71/56 | Cell Membrane | Transport |
| Q13228 | 5.93 | 52928 | 9 | 15% | 83/56 | Cell Membrane | Transport |
| Q9NVA2 | 6.36 | 49652 | 9 | 27% | 110/56 | Nucleus | Cell cycle |
| Q92599 | 5.89 | 56234 | 9 | 22% | 104/56 | Nucleus | Cell cycle |
| Q8TDX7 | 8.49 | 34985 | 7 | 22% | 66/56 | Cytoplasma | Cell cycle |
| Q00536 | 7.23 | 55909 | 7 | 15% | 68/56 | Cytoplasma | Cell cycle |
| P36952 | 5.72 | 42568 | 7 | 28% | 81/56 | Secreted | Protease inhibitor |
| P55854 | 5.32 | 11687 | 5 | 37% | 81/56 | Cytoplasma | Protein degradation |
| P31948 | 6.4 | 63227 | 9 | 20% | 62/56 | Cytoplasma | Protein folding |
| Q8NBS9 | 5.63 | 48283 | 7 | 22% | 68/56 | ER | Redox regulation |
| Q8NBS9 | 5.63 | 48283 | 9 | 26% | 124/56 | ER | Redox regulation |
| Q9UI15 | 6.84 | 22629 | 6 | 27% | 63/56 | Cytoplasma | Unknown |
| P60174 | 6.45 | 26938 | 12 | 66% | 142/56 | Cytoplasma | Metabolism |
| P60174 | 6.45 | 26938 | 7 | 34% | 95/56 | Cytoplasma | Metabolism |
| P67936 | 4.67 | 28619 | 7 | 22% | 80/56 | Cytoplasma | Cell motility/Ca |
| | | | | | | | regulation |
| P61088 | 6.13 | 17184 | 6 | 41% | 70/56 | Nucleus | Gene Regulation |
| Q5VYV7 | 9.5 | 46094 | 5 | 17% | 58/56 | Unknown | Unknown |
| P08670 | 5.06 | 53676 | 6 | 15% | 70/56 | Cytoplasma | Cytoskeleton |
| P08670 | 5.06 | 53676 | 16 | 32% | 93/56 | Cytoplasma | Cytoskeleton |
| P21796 | 8.62 | 30868 | 8 | 40% | 110/56 | Mito | Transport |
| P45880 | 7.49 | 32060 | 6 | 31% | 84/56 | Mito | Transport |
| Q2VY69 | 8.77 | 71198 | 8 | 11% | 59/56 | Nucleus | Gene Regulation |
| Q8N7K0 | 9.38 | 79872 | 11 | 24% | 75/56 | Nucleus | Gene Regulation |
| Q6ZNA1 | 9.39 | 111011 | 6 | 8% | 56/56 | Nucleus | Gene Regulation |

*The subcellular locations and functional classes of identified proteins were
obtained from the Uniprot website.

### EXAMPLE 8

### Validation of Characterized Breast Cancer Related Proteins Through Immunoblotting and Immunofluorescence

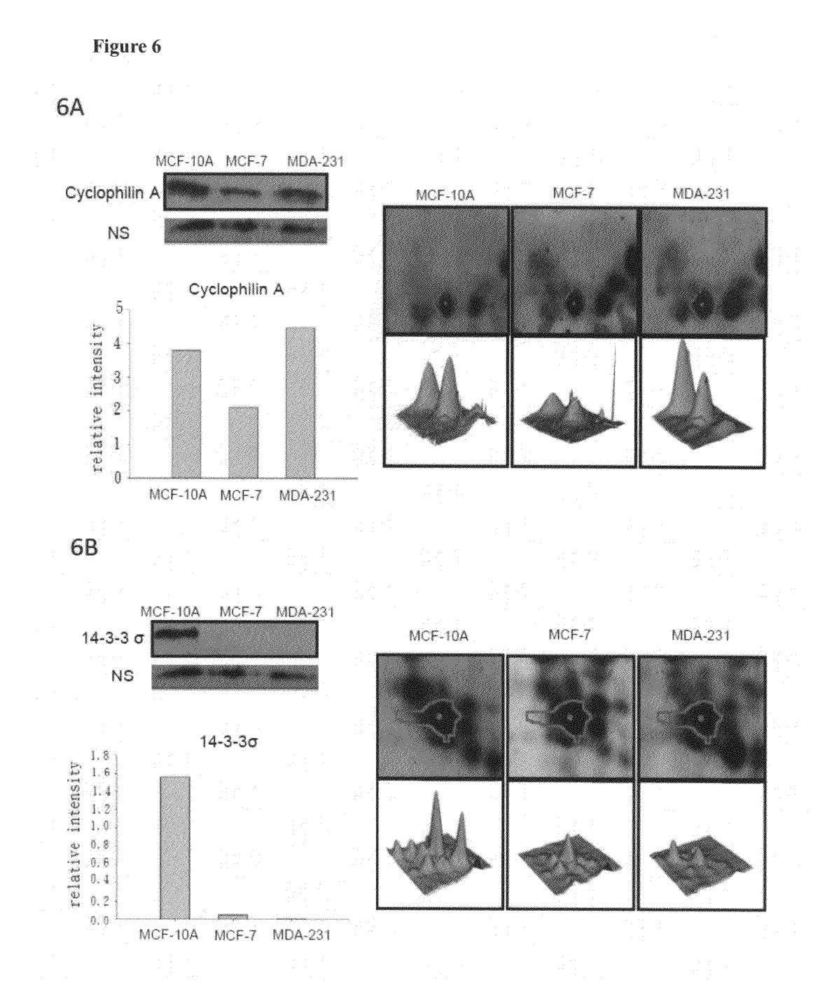

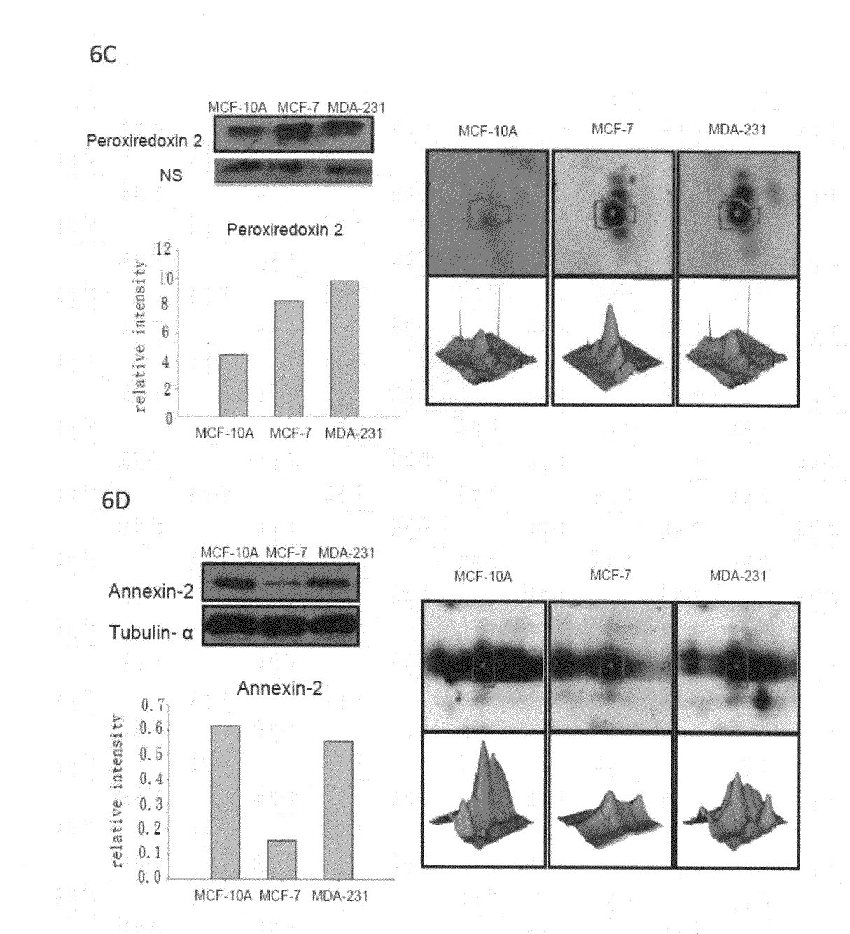

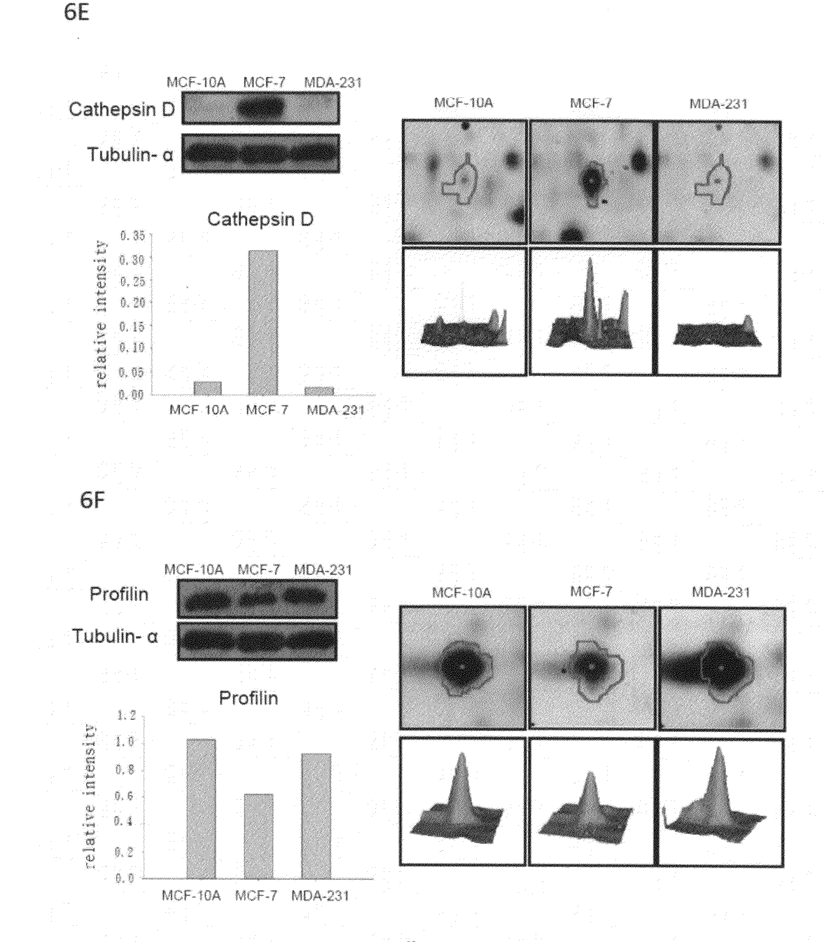

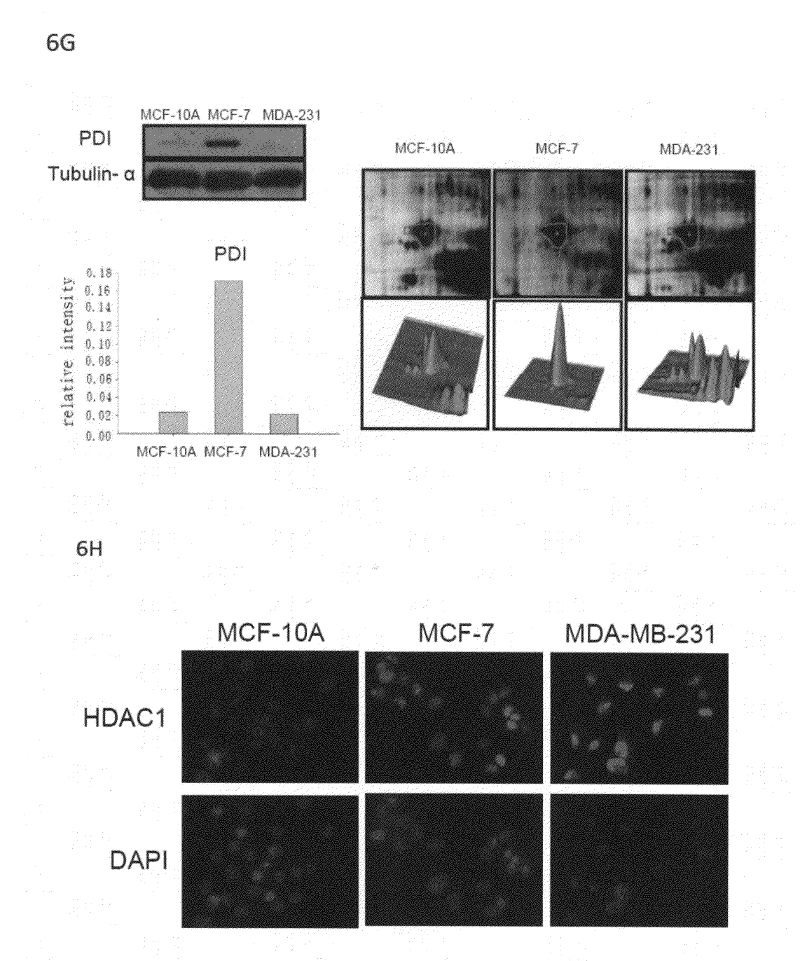

The secrometic experiment of the present invention indentified some of the well-characterized breast cancer related cytosolic proteins such as Cyclophilin A, 14-3-3 delta and peroxiredoxin 2 in culture media. It wa essential to validate the levels of these cytosolic proteins in the medium from independent experiments. To this end, the expression level of cyclophilin A, 14-3-3 delta and peroxiredoxin 2 from the culture media of MDA-MB-231, MCF-7 and MCF-10A were validated with immunoblotting. The results indicated that both the proteomic and immunoblot analysis showed cyclophilin A and 14-3-3 delta down-regulated in MCF-7 in comparison to the levels in MCF-10A. In contrast, peroxiredoxin 2 showed up-regulation in MCF-7 in comparison to the levels in MCF-10A. Comparing the secreted protein levels between MCF-10A and MDA-MB-231 indicates that the peroxiredoxin 2 and 14-3-3 delta expression levels increased in MDA-MB-231 and MCF-10A, respectively; however, the cyclophilin A level showed no significant change (FIG. 6 A˜C). This observation confirmed that cyclophilin A, 14-3-3delta and peroxiredoxin 2 were differentially secreted across the breast cells.

Immunoblot and immunofluorescence analyses were carried out to further confirm the differential protein levels observed in the total cellular proteins (profilin, cathepsin D, annexin 2, protein disulfide isomerase A1 and HDAC1) across MDA-MB-231, MCF-7 and MCF-10A (FIG. 6 D˜H). These proteins have been reported to play important roles in cytoskeleton regulation, proteolysis, calcium regulation, protein disulfide bond rearrangement and chromatin assembly during tumorigenesis. The results of the immunoblotting indicated that cathepsin D and PDI showed up-regulation in MCF-7 cells but down-regulation in MDA-MB-231 compared to the two protein expressions in MCF-10A. The expression levels of the profilin and annexin 2 proteins showed down-regulation in MCF-7 but no significant changes in MDA-MB-231 compared to the levels in MCF-10A. These immunoblotting results demonstrated a positive correlation with the 2D-DIGE results (FIG. 6 D˜G). In addition to immunoblotting, validation was also performed with immunofluorescent analysis. FIG. 6H shows that most of the HDAC1 signal was distributed within the nucleus, which is consistent with the subcellular location of HDAC1 in cells. As expected, the fluorescent intensity with the same exposure indicates that HDAC1 showed increased expressions in MCF-7 and MDA-MB-231 compared to its expression in MCF-10A. Altogether, the results from immunoblotting and immunofluorescent agreed with the results from 2D-DIGE data.

### EXAMPLE 9

### Validation of Unreported Identified Putative Tumorigenesis Markers Through Immunoblotting and Immunofluorescence

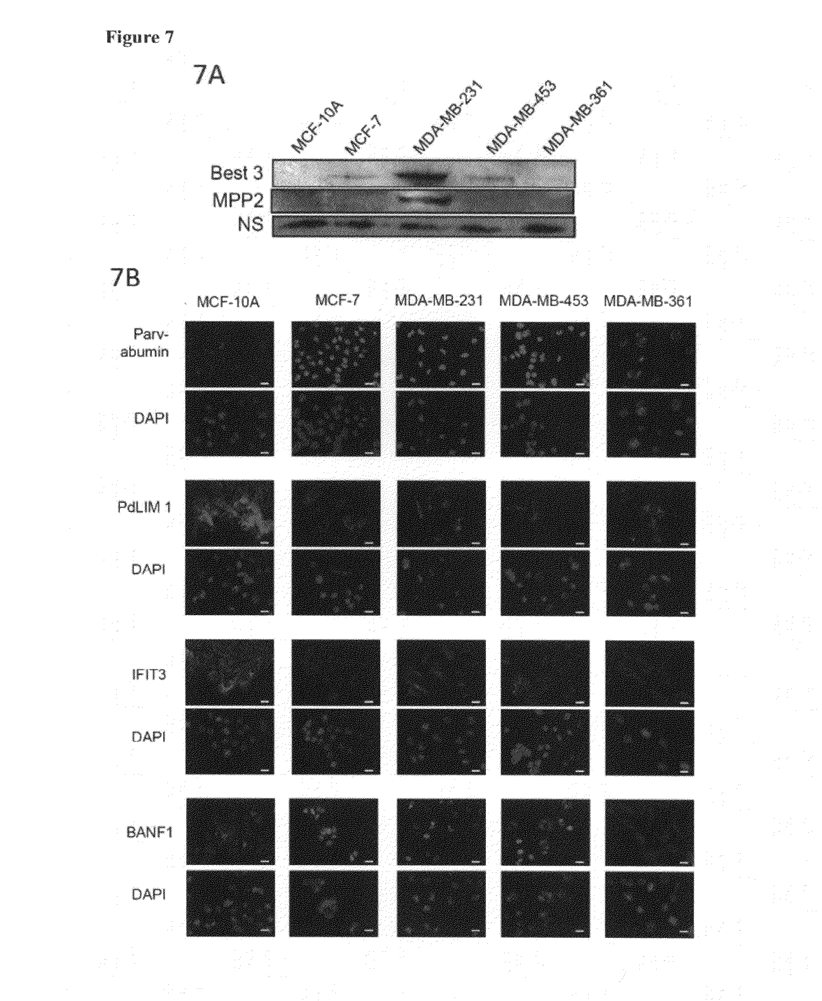

The cellular proteomic and secretomic analyses above reveal a number of identified proteins may be breast cancer markers (Tables 1 and 2). To verify this observation, immunoblotting and immunofluorescence were used to validate these differentially expressed proteins including bestrophin 3, MPP2, parvalbumin, PdLIM1, IFIT3 and BANF1 as these proteins showed relatively significant changes (>3 fold) in comparison with most of the unreported identified proteins across MCF-10A, MCF-7 and MDA-MB-231. The immunoblotting analysis of concentrated serum-free media shows that more bestrophin 3 was secreted in the cell lines of MCF-7 and MDA-MB-231 than MCF-10A, while MPP2 was only detected in MDA-MB-231. Notably, the bestrophin 3 blotting result did not completely agree with the 2D-DIGE data, where levels in MCF-7 were higher than MB-231 (FIG. 7A). Using immunofluorescent staining, the robust increase of parvalbumin signal in both the MCF-7 and MDA-MB-231 cells was first confirmed after comparison with the signal in MCF-10A. Parvalbumin was primarily localized in the nucleus, which coincided with the DAPI stained nucleus. Further investigation of parvabumin expression in other breast cancer cell lines indicated that parvabumin was over-expressed in MDA-MB-453, a line of non-invasive breast cancer cells, and slightly up-regulated in MDA-MB-361, an adenocarcinoma with metastatic ability (FIG. 7B). These results implied that parvabumin might have the potential to be a breast cancer marker. In contrast, PdLIM1, a cytosolic protein, was down-regulated in all breast cancer lines: MCF-7, MDA-MB-231, MDA-MB-453 and MDA-MB-361 (FIG. 7B). In addition, IFIT3, a plasma membrane protein, was down-regulated in transformed cells, especially in MCF-7 and MDA-MB-231, and was consistent with the proteomic data from 2D-DIGE (FIG. 7B). Interestingly, BANF1, a major nucleus-located protein, was distributed in the cytoplasma of the MCF-10A cells, but was confined within the nucleus in MCF-7, MDA-MB-231 and MDA-MB-453 cells; in addition, BANF1 was distributed within the cytoplasma and nucleus in MDA-MB-361 (FIG. 7B). These results indicated that the BANF1 levels were different between normal breast cells and breast cancer cells, and that the subcellular locations of the protein may account for tumorigenesis.

With the basis of a Swiss-Prot search and KEGG pathway analysis, numerous potential biological functions of the identified proteins across MCF-10A, MCF-7 and MDA-MB-231 were determined. The information should be useful for studying the mechanisms of breast cancer tumorigenesis and metastasis.

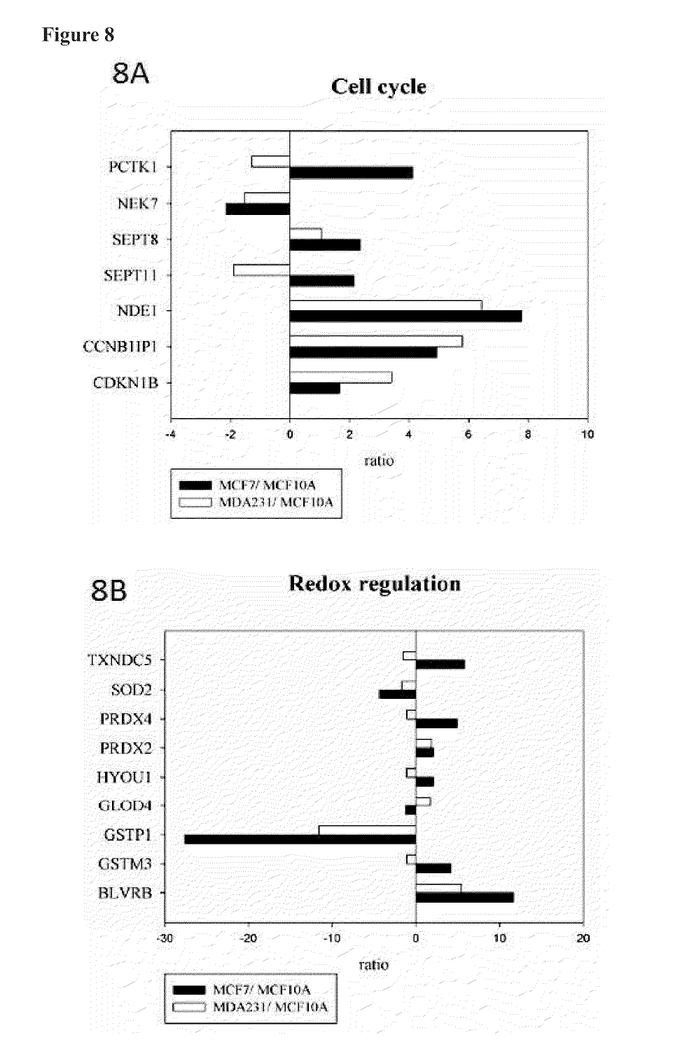

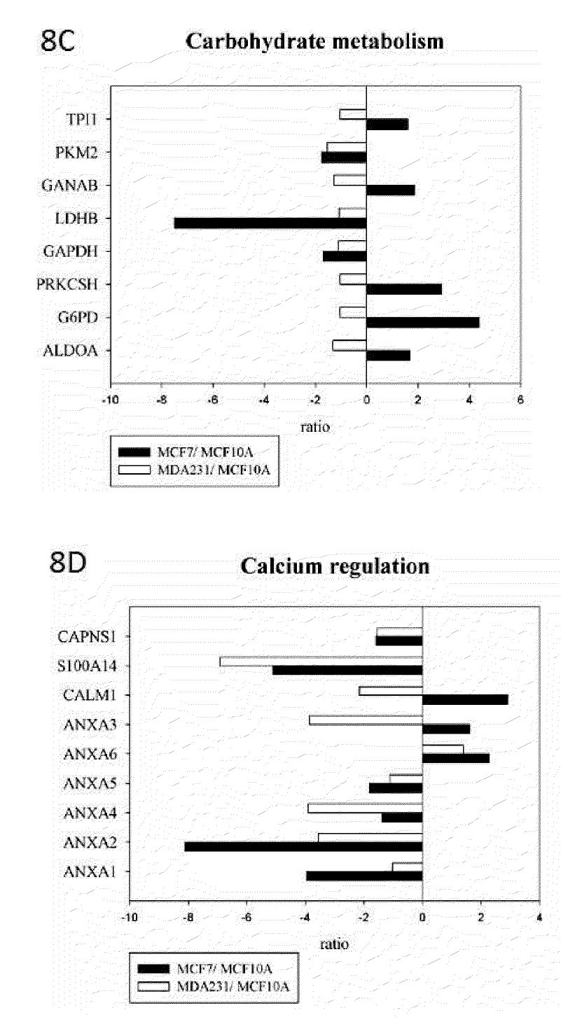

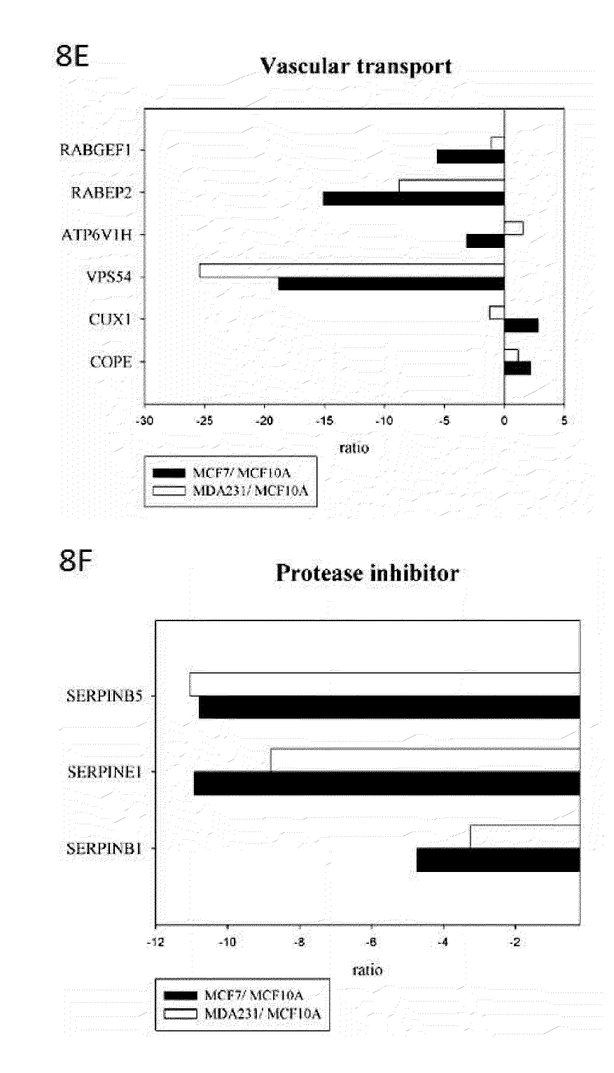

FIG. 8 compared the expression profiles of the identified differentially expressing proteins in these 3 cell lines. Proteins known to regulate cell cycle are found to be upregulated in both MCF-7 and MDA-MB-231 (FIG. 8A), and are associated with the promotion of tumorigenesis. In addition, the expression of proteins linked to redox-regulation increased in the MCF-7 cells in comparison to the levels in MCF-10A (FIG. 8B). Induced expression of these proteins may account for cancer development and progression. Proteomic analysis also reveals that proteins involved in carbohydrate metabolism are significantly over-expressed in MCF-7 cells (FIG. 8C). This demonstrates that cancer cells rely heavily on glycolysis to obtain ATP for proliferation and tumorigenesis in the presence of adequate oxygen levels; this mechanism has been implicated in numerous cancer therapies. FIGS. 8D˜F show the downregulated profiles of proteins in both MCF-7 and MDA-MB-231 cells. These proteins are involved in calcium regulation, vascular transport and protease inhibition. Calcium-binding proteins, such as annexin 1, whose function is modulated by an estrogen receptor, have been reported to show decreased expression in correlation with breast cancer development and progression. The S100 protein family is a family of low molecular weight calcium-binding proteins that is responsible for the regulation of protein phosphorylation, intracellular calcium homostasis, the dynamics of cytoskeleton constituents and cell proliferation. S100A14 was identified as downregulated in MCF-7 and MDA-MB-231, suggesting its potential role in breast cancer. Howerever, proteins involved in vascular transport, including Rab GTPase-binding effector protein and vacuolar protein sorting-associated protein 54, were decreased in expression in MCF-7 and MDA-MB-231 (FIG. 8F). This may be explained by a previous report indicating that the downregulation of Rab5 GDP/GTP exchange factor enhances receptor tyrosine kinase signaling and promotes the growth factor-directed migration of tumor cells (Hu, H.; Milstein, M.; Bliss, J. M.; Thai, M.; Malhotra, G; Huynh, L. C.; Colicelli, J. Mol. Cell Biol. 2008, 28, 1573). However, there are few studies on tumorigenesis regarding the roles of the Rab GTPase-binding effector protein and the vacuolar protein sorting-associated protein 54. Serpin is a group of proteins able to inhibit protease and block the growth, invasion, and metastatic properties of breast tumors. Hence, serpin families function as tumor suppressors in cancer research. The downregulation of serpin is well-correlated with the progression of breast cancer and the present observations in MCF-7 and MDA-MB-231 cells (FIG. 8F).

Other differentially expressed proteins of interest across MCF-10A, MCF-7 and MDA-MB-231 include cathepsin D, bestrophin-3 and interferon-induced protein with tetratricopeptide repeats 3 (IFIT3). Cathepsin D, a lysosomal aspartic protease, is over-expressed in estrogen receptor positive breast cancer cells and is generally of good prognostic value in comparison with estrogen receptor negative breast cancer in clinical studies. The present invention indicates that cathepsin D is highly expressed in MCF-7, both in total cellular proteins or in secreted fraction. In contrast, cathepsin D is significantly down-regulated in MDA-MB-231 cells compared with MCF-7.

Results of the proteomic experiments display good correlation with secrmetic experiments.

Bestrophin-3, a cGMP-dependent calcium-activated chloride channel, has not been reported to be associated with cancer and shows upregulation in MCF-7 and MDA-MB-231 in the present inveniton. Nevertheless, the related study in bestrophin-1 showed the protein improves intracellular Ca²⁺ signaling and increases cell growth rate in colonic carcinoma cells. The proliferation of the cells was significantly suppressed by bestrophin-1 RNA interference treatment (Spitzner, M.; Martins, J. R.; Soria, R. B.; Ousingsawat, J.; Scheidt, K.; Schreiber, R.; Kunzelmann, K. J. Biol. Chem. 2008, 283, 7421). This indicated that bestrophin-3 may be a potential target for breast cancer therapy. IFIT3 plays a key role in the antiproliferative activity of the interferon-related signaling pathway through inducing expression of cell cycle inhibitors, p21 and p27 proteins (Xiao, S.; Li, D.; Zhu, H. Q.; Song, M. G; Pan, X. R.; Jia, P. M.; Peng, L. L.; Dou, A. X.; Chen, G. Q.; Chen, S. J.; Chen, Z.; Tong, J. H. Proc. Natl. Acad. Sci. U.S.A 2006, 103, 16448). The 2D-DIGE results in this invention showed that IFIT3 is downregulated in both MCF-7 and MDA-MB-231 cells, implying that breast cancer cells may maintain a high level of proliferative activity by downregulating the expression of IFIT3.

Based upon the data presented here, the present invention infers that proteins selected from biomarker library plays key role in the regulation of breast cancer progression. Combining the data of 2D-DIGE and immunoassay, it concludes that the increasing or decreasing of biomarker expression relative to the expression of normal tissue results in an increased likelihood of breast cancer development.

What is claimed is:

1. A breast cancer biomarker library, comprising bestrophin-3, carbonic anhydrase 2, dynein heavy chain 6, ecto-ADP-ribosyltransferase 4, GRAM domain-containing protein 2, interferon-induced protein with tetratricopeptide repeat 3, phosphoglycerate mutase 1, proteasome subunit alpha type-1, proteasome subunit alpha type-3, rab GTPase-binding effector protein 2, Ras-related protein Rab-2B, selenium-binding protein 1, transmembrane protein C14orf180, vascular protein sorting-associated protein 54, achaete-scute homologue 4, aconitate hydratase, aminopeptidase B, annexin A3, barrier-to-autointegration factor, bifunctional purine biosynthesis, calumenin, carbonic anhydrase 2, coiled-coil domain-containing protein, erlin-2, F-actin-capping protein subunit beta, flavin reductase, fructose-1,6-biphosphatase 1, fructose-biphosphate ldolase A, heat shock protein 75 kDa, heterogeneous nuclear ribonucleoproteins A2/B 1, leukotriene A-4 hydrolase, microfibrillar-associated protein 3 like, microtubule-associated protein RP, nuclear distribution protein nudE homologue 1, parvalbumin alpha, PDZ and LIM domain protein 1, peptidylprolyl isomerase domain and WD repeat-containing protein 1, phosphoserine aminotransferase, plastin-3, programmed cell death 6-interacting protein, proteasome activator complex subunit 1, proteasome activator complex subunit 2, protein canopy homologue 2, protein CASC2, protein disulfide-isomerase A6, protein SHQ1, Rab GDP dissociation inhibitor beta, reticulocalbin-2, Rho GTPase-activating protein 25, Rho GTPase-activating protein 5, ribonuclease inhibitor, selenium-binding protein 1, septin-11, septin-8, serine/threonine-protein kinase Nek7, serine/threonine-protein kinase PCTAIRE-1, small ubiqutin-related modifier 3, stress-induced phosphoprotein 1, thioredoxin domain-containing protein 5, ubiquitin-conjugating enzyme E2, UPF0492 protein C20orf94, voltage-dependent anion-selective channel protein and zinc finger protein 433.

2. A method of predicting an increased likelihood of developing breast cancer progression of a subject comprising:
(c) detecting the expression of at least one biomarker in a sample from a subject with bioassays, wherein the biomarker is selected from the biomarker library of claim 1; and1
(d) comparing the pattern of biomarker expression in (a) to a reference biomarker expression pattern from normal tissue, wherein at least one fold of increasing or decreasing biomarker expression relative to the reference indicating an increased likelihood of breast cancer development.

3. The method of claim 2, wherein the breast cancer progression includes the presence or absence of breast tumor, the stage of breast cancer and the effectiveness of breast cancer treatment.

4. The method of claim 3, wherein the stage of breast cancer includes invasive and non-invasive tumor pregression.

5. The method of claim 2, wherein the subject is human or mammal.

6. The method of claim 2, wherein the sample is selected from blood, serum, plasma, ductal lavage fluid, nipple aspiration fluid.

7. The method of claim 2, wherein the bioassays comprises immunoassay, electrophoresis and mass spectrometry.

8. The method of claim 7, wherein the immunoassay is measured using immunoblotting.

9. The method of claim 8, wherein the immunoblotting is an antibody-based assay.

10. The method of claim 2, while further comprises applying software for protein expression comparison between normal tissue and tumor tissue.

11. The method of claim 2, wherein the expression pattern indicates the quantity of biomarker expression.

12. The method of claim 2, wherein the increasing or decreasing of biomarker expression is 1.5 fold relative to the biomarker expression of normal tissue.
